(19) United States
(12) Patent Application Publication
(10) Pub. No.: US 2010/0183971 A1
(43) Pub. Date: Jul. 22, 2010

(54) MAGNETIC CARRIER, TWO-COMPONENT DEVELOPER AND IMAGE FORMING METHOD

(75) Inventors: Hiroyuki Fujikawa, Yokohama-shi (JP); Koh Ishigami, Mishima-shi (JP); Kunihiko Nakamura, Gotemba-shi (JP); Nozomu Komatsu, Mishima-shi (JP); Yoshinobu Baba, Yokohama-shi (JP); Takeshi Yamamoto, Yokohama-shi (JP); Manami Haraguchi, Yokohama-shi (JP); Kenta Kubo, Kamakura-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/691,063

(22) Filed: Jan. 21, 2010

Related U.S. Application Data
(63) Continuation of application No. PCT/JP2009/064087, filed on Aug. 4, 2009.

(30) Foreign Application Priority Data
Aug. 4, 2008 (JP) 2008-200643

(51) Int. Cl. G03G 9/113; G03G 9/107; G03G 9/08; G03G 13/20

(52) U.S. Cl. 430/110.3; 430/111.41; 430/124.23; 430/124.1

(57) ABSTRACT

A magnetic carrier having magnetic carrier particles each containing at least a magnetic core particle and a resin; the magnetic carrier having a resistivity of from 1.0×10⁶ Ω·cm or more to 1.0×10¹⁰ Ω·cm or less at an electric-field intensity of 1.0×10³ V/cm as found by measuring dynamic impedance; electric-field intensity E(10⁹) at which the resistivity of the magnetic carrier comes to 1.0×10⁹ Ω·cm being 2.0×10⁴ V/cm or less, and electric-field intensity E(10⁸) at which the resistivity of the magnetic carrier comes to 1.0×10⁸ Ω·cm being from 5.0×10³ V/cm or more to 2.8×10⁴ V/cm or less; and the electric-field intensity E(10⁸) and the electric-field intensity E(10⁹) being in a ratio, E(10⁸)/E(10⁹), of from 1.0 or more to 5.0 or less.

### CROSS-REFERENCE TO RELATED APPLICATIONS

This application is a continuation of International Application No. PCT/JP/2009/064087, filed Aug. 4, 2009, which claims the benefit of Japanese Patent Application No. 2008-200643, filed Aug. 4, 2008.

### BACKGROUND OF THE INVENTION

1. Field of the Invention

This invention relates to a magnetic carrier, a two-component developer and an image forming method which are used in an electrophotographic system, an electrostatic recording system or an electrostatic printing system.

2. Description of the Related Art

The step of developing an electrostatically charged image (an electrostatic latent image) in the electrophotographic system is a step in which a toner having triboelectrically been charged is made to exist on the electrostatically charged image by utilizing electrostatic mutual action of the electrostatically charged image, to form a visible image. In order to develop the electrostatically charged image, available are a one-component developer making use of a magnetic toner composed of a resin and a magnetic material dispersed therein and a two-component developer making use of a magnetic toner and a magnetic carrier in the form of a blend. In particular, in full-color image forming apparatus such as full-color copying machines and full-color printers, which are required to be of high image quality, the two-component developer is preferably used. Also, in recent years, the evolution of the electrophotographic system into a POD (print on-demand) field requires high-speed printability and high-quality image printing. As the result, for print image quality as well, in addition to images with a higher definition, it has become desirous to obtain print results free of any image defects and giving a high image quality over a long period of time.

In developing systems making use of the two-component developer, a two-component developer held on a developer carrying member a developing assembly has is transported to a development zone where the developer carrying member faces an electrostatic latent image bearing member holding an electrostatic latent image thereon. Then, a magnetic brush formed of the two-component developer on the developer carrying member is brought into contact with or proximity to the electrostatic latent image bearing member. Then, a toner the two-component developer has is transferred to (participate in development on) the surface of the electrostatic latent image bearing member by the aid of a stated development bias applied to the part (SD gap) between the developer carrying member and the electrostatic latent image bearing member. Thus, a toner image corresponding to the electrostatic latent image is formed on the electrostatic latent image bearing member. On this occasion, if the magnetic carrier that carries and transport the toner has a too low electrical resistance, electric charges are injected from the developer carrying member to the electrostatic latent image through the magnetic carrier. As the result, the electrostatic latent image may come disturbed to cause halftone coarse images and image defects such as image white dots due to transfer of the magnetic carrier onto the electrostatic latent image bearing member (i.e., carrier sticking).

In addition, in order to compete in the field of POD (print on-demand), it has become necessary to form electrostatic latent images at a high resolution. For example, in the case of 2,400 dpi, dot formation width for 1 dpi is as extremely small as about 20 μm. For example, when such minute electrostatic latent images are formed, the injection of electric charges from the developer carrying member through the magnetic carrier as stated above influences the electrostatic latent images. Thus, it is sought to complete the developing step without disturbing such minute electrostatic latent images.

In order to prevent the electrostatic latent images from being disturbed due to the injection of electric charges and prevent the carrier sticking, it is effective to set the electrical resistance of the magnetic carrier at a high level. Alternatively, it is effective to set low the Vpp (peak-to-peak voltage) of development bias that is an alternating bias voltage, so as to hold down the level of movement of electric charges between the electrostatic latent image bearing member and the magnetic carrier. However, setting the Vpp of development bias low may lessen the injection of electric charges from the developer carrying member through the magnetic carrier, but weakens the electric field applied to the two-component developer. Hence, the force that separates the toner from the magnetic carrier may decrease to lower image density. Also, if the magnetic carrier has a high electrical resistance, electric charges (counter charges) having come accumulated on the magnetic carrier can not readily move. Hence, the electric charges of such a magnetic carrier and the electric charges of the toner may attract each other to produce a large adhesion, so that it may become hard for the toner to come separated from the carrier, resulting in a lowering of image density.

Thus, it is difficult at present to achieve both i) the remedy of halftone coarse images due to the disturbance of electrostatic latent images that is caused by the injection of electric charges and image defects due to carrier sticking and ii) the maintenance of image density, and various proposals have been made.

Japanese Patent Laid-open Application No. H09-197720 discloses a proposal of a carrier the volume specific resistance of which in the state of a magnetic brush has been formed is 10¹¹ Ω·cm or more under application of an electric field of 10³ V/cm and from 10^{6.2} Ω·cm to 10^{9.8} Ω·cm under application of an electric field of 10⁴ V/cm. This carrier can provide good images without any carrier sticking. Japanese Patent Laid-open Application No. H10-148972 discloses a proposal of a carrier showing an impedance of 1.0×10⁸ Ω·cm or more. This carrier can provide high-definition images without any edge effect even after 30,000-sheet paper feed running, may less cause fog and can also prevent in-machine staining.

However, these carriers have not succeeded in achieve both i) the remedy of halftone coarse images due to the disturbance of electrostatic latent images that is caused by the injection of electric charges and image defects due to carrier sticking and ii) the maintenance of image density that are as stated above. Hence, these can not be said to have sufficiently satisfied any image quality in high-speed printing in the market of POD printing, thus it is required to further enhance image quality and improve running stability.

Accordingly, in order to further enhance image quality and improve running stability, a magnetic material dispersed resin carrier having a magnetic material standing dispersed in a resin is proposed, which has advanced in making lower in specific resistance and lower in magnetic force. For example, Japanese Patent Laid-open Application No. H08-160671 discloses a proposal of a magnetic material dispersed resin carrier which is high in electrical resistance and low in magnetic force. Japanese Patent Laid-open Application No.2006-337579 also discloses a proposal of a resin-filled ferrite carrier the particles of which have a void of 10 to 60% and the voids of which are filled with a resin. Such carriers as the above can achieve improvement in sufficiently high image quality and high definition and in higher durability as it has a lower specific gravity and a lower magnetic force. However, it may make the toner have an inferior developing performance to cause, e.g., a lowering of image density. The factor of such a lowering of developing performance is that a low electrode effect results because the carrier becomes higher in electrical resistance. As the result, the toner at the rear end of a halftone area may come scraped off at the boundary between the halftone area and a solid-black area to make white lines, to cause image defects in which edges of solid-black areas stand emphasized (hereinafter “boundary blanks”).

Accordingly, a method is proposed in which, in order to improve developing performance and improve image quality, the development gap (the distance between a photosensitive member and a developing sleeve) is set narrow and a high electric field is applied to this development gap. It, however, has turned out that employing such construction enables sufficient achievement for the developing performance but on the other hand causes a phenomenon that ring-like or spot-like patterns appear on recording sheets (hereinafter “ring marks”). Japanese Patent Laid-open Application No. H08-082988 discloses an attempt to remedy ring marks coming from a discharge phenomenon, by applying an alternating electric field in such a way that a maximum development electric field formed at the development gap may be 2.8×10⁴ V/cm or less. However, in the case of making the development gap much narrower or the case of a ferrite carrier made smaller in carrier particle diameter or made lower in specific resistance, the ring marks can not be kept from appearing or conversely the developing performance can not sufficiently be achieved, thus it is difficult in some cases to achieve the both of these.

### SUMMARY OF THE INVENTION

An object of the present invention is to provide a magnetic carrier, a two-component developer and an image forming method which have resolved the above problems.

Another object of the present invention is to provide a magnetic carrier, a two-component developer and an image forming method which enable high-quality images to be obtained over a long period of time, promising superior developing performance.

Stated specifically, an object of the present invention is to provide a magnetic carrier, a two-component developer and an image forming method which enable the development to be performed in a good efficiency and the image density to be sufficiently secured at such a low electric-field intensity that may cause no ring marks, and enable over a long period of time the image density to be kept from varying. It also provides a magnetic carrier, a two-component developer and an image forming method which enable images to be obtained with less fog and halftone coarse images and with less boundary blanks and carrier sticking.

The above objects can be achieved by using a magnetic carrier, a two-component developer and an image forming method which are described below.

The present invention provides a magnetic carrier which has magnetic carrier particles, each magnetic carrier particle containing at least a magnetic core particle and a resin; the magnetic carrier having a resistivity of from 1.0×10⁶ Ω·cm or more to 1.0×10¹° Ω·cm or less at an electric-field intensity of 1.0×10³ V/cm as found by measuring dynamic impedance; electric-field intensity E(10⁹) at which the resistivity of the magnetic carrier comes to 1.0×10⁹ Ω·cm being 2.0×10⁴ V/cm or less, and electric-field intensity E(10⁸) at which the resistivity of the magnetic carrier comes to 1.0×10⁸ Ω·cm being from 5.0×10³ V/cm or more to 2.8×10⁴ V/cm or less; and the electric-field intensity E(10⁸) and the electric-field intensity E(10⁹) being in a ratio, E(10⁸)/E(10⁹), of from 1.0 or more to 5.0 or less.

The present invention also provides a two-component developer containing at least the above magnetic carrier and a toner.

The present invention further provides an image forming method which has: a charging step of charging an electrostatic latent image bearing member electrostatically by a charging means; an exposure step of exposing to light the electrostatic latent image bearing member thus charged, to form an electrostatic latent image thereon; a developing step of forming a magnetic brush on a developer carrying member by means of a two-component developer and, in the state the magnetic brush is brought into contact with, and between, the electrostatic latent image bearing member and the developer carrying member, applying development bias across the electrostatic latent image bearing member and the developer carrying member to form an electric field across the electrostatic latent image bearing member and the developer carrying member, during which the electrostatic latent image is developed with a toner the two-component developer has, to form a toner image on the electrostatic latent image bearing member; a transfer step of transferring the toner image from the electrostatic latent image bearing member to a transfer material via, or not via, an intermediate transfer member; and a fixing step of fixing the toner image held on the transfer material, by the action of heat and/or pressure; the above two-component developer being used as the two-component developer, and the development bias being formed by superimposing an alternating electric field on a direct-current electric field.

The use of the magnetic carrier, two-component developer and image forming method of the present invention can provide a magnetic carrier, a two-component developer and an image forming method which enable formation of high-quality images over a long period of time, promising superior developing performance.

Further features of the present invention will become apparent from the following description of exemplary embodiments with reference to the attached drawings.

### BRIEF DESCRIPTION OF THE DRAWINGS

FIG. 1 is a schematic view of a dynamic impedance measuring instrument used in the present invention.

FIG. 2 is a schematic view of an image forming apparatus used in the present invention.

FIG. 3 is a schematic view of another image forming apparatus used in the present invention.

FIG. 4 is a chart showing a Cole-Cole plot obtained by the measurement of dynamic impedance.

FIG. 5 is a schematic view of an instrument for measuring the specific resistance of magnetic core particles used in the present invention.

FIG. 6 is a graph showing the resistivity of magnetic carriers obtained in the present invention.

### DESCRIPTION OF THE EMBODIMENTS

The magnetic carrier of the present invention is described first.

The present invention is a magnetic carrier which has magnetic carrier particles each containing at least a magnetic core particle and a resin, and is characterized in that the magnetic carrier has a resistivity of from 1.0×10⁶ Ω·cm or more to 1.0×10¹⁰ Ω·cm or less at an electric-field intensity of 1.0×10³ V/cm as found by measuring dynamic impedance, that electric-field intensity E(10⁹) at which the resistivity of the magnetic carrier comes to 1.0×10⁹ Ω·cm is 2.0×10⁴ V/cm or less and electric-field intensity E(10⁸) at which the resistivity of the magnetic carrier comes to 1.0×10⁸ Ω·cm is from 5.0×10³ V/cm or more to 2.8×10⁴ V/cm or less, and that the electric-field intensity E(10⁸) and the electric-field intensity E(10⁹) are in a ratio, E(10⁸)/E(10⁹), of from 1.0 or more to 5.0 or less.

According to studies made by the present inventors, it has turned out that the resistivity of magnetic carrier that is found by measuring dynamic impedance correlates with behaviors having to do with the exchange of electric charges between the developer carrying member and the electrostatic latent image bearing member (charge injection and counter-charge attenuation); the electric charges actually standing generated in the interior of the image forming apparatus.

Then, these behaviors have a great influence on developing performance and carrier sticking, and hence the controlling of the resistivity of magnetic carrier that is found by measuring dynamic impedance enables improvement in the developing performance and prevention of the carrier sticking.

In the present invention, the image density can sufficiently be secured even at a low electric-field intensity, the image density may less vary over a long period of time and images can be obtained with less fog and halftone coarse images and with less boundary blanks and carrier sticking in the case when the magnetic carrier has a resistivity of from 10 ×10⁶ Ω·cm or more to 1.0×10¹⁰ Ω·cm or less at an electric-field intensity of 1.0×10³ V/cm; electric-field intensity E(10⁹) at which the resistivity of the magnetic carrier comes to 1.0×10⁹ Ω·cm is 2.0×10⁴ V/cm or less, and electric-field intensity E(10⁸) at which the resistivity of the magnetic carrier comes to 1.0×10⁸ Ω·cm is from 5.0×10³ V/cm or more to 2.8×10⁴ V/cm or less; and the electric-field intensity E(10⁸) and the electric-field intensity E(10⁹) are in a ratio, E(10⁸)/E(10⁹), of from 1.0 or more to 5.0 or less.

In the case when the magnetic carrier has a resistivity of from 1.0×10⁶ Ω·cm or more to 1.0×10¹⁰ Ω·cm or less at an electric-field intensity of 1.0×10³ V/cm, the toner may not easily come to scatter and also the boundary blanks may not easily occur.

Where any data at the electric-field intensity of 1.0×10³ V/cm are not present, two points on the side to be extrapolated are connected with a straight line to make extrapolation, and a point at which the straight line drawn by extrapolation and the vertical line at the electric-field intensity of 1.0×10³ V/cm intersect is taken as the resistivity of the magnetic carrier at the electric-field intensity of 1.0×10³ V/cm.

If the magnetic carrier has a resistivity of less than 1.0×10⁶ Ω·cm at the electric-field intensity of 1.0×10³ V/cm, electric charges may move inside the magnetic carrier at so excessively large level that the electric charges may come to leak onto the electrostatic latent image bearing member or the toner may come to scatter in the developing assembly.

If the magnetic carrier has a resistivity of more than 1.0×10¹⁰ Ω·cm at the electric-field intensity of 1.0×10³ V/cm, the developing performance may lower to cause boundary blanks.

It has also turned out that the electric-field intensity E(10⁹) at which the resistivity of the magnetic carrier comes to 1.0×10⁹ Ω·cm correlates with the attenuation of counter charges coming generated on the surfaces of magnetic carrier particles at the time of development. It has still also turned out that the electric-field intensity E(10⁸) at which the resistivity of the magnetic carrier comes to 1.0×10⁸ Q·cm correlates with the easiness in charge injection onto the electrostatic latent image bearing member.

Accordingly, in the present invention, it is important that the electric-field intensity E(10⁹) at which the resistivity of the magnetic carrier comes to 1.0×10⁹ Ω·cm is 2.0×10⁴ V/cm or less, which may preferably be 1.5×10⁴ V/cm or less, and much preferably 1.3×10⁴ V/cm or less.

Where any data are not present at the electric-field intensity E(10⁹) at which the resistivity of the magnetic carrier comes to 1.0×10⁹ Ω·cm, two points on the side to be extrapolated are connected with a straight line to make extrapolation, and a point at which the straight line drawn by extrapolation and the vertical line at the resistivity 1.0×10⁹ Ω·cm intersect is taken as the electric-field intensity E(10⁹).

Inasmuch as the electric-field intensity E(10⁹) at which the resistivity of the magnetic carrier comes to 1.0×10⁹ Ω·cm is 2.0×10⁴ V/cm or less, the counter charges coming generated on the surfaces of magnetic carrier particles at the time of development can readily attenuate. Hence, the toner can readily be separated from the carrier to bring an improvement in developing performance. The improvement in developing performance also makes image defects such as boundary blanks less occur.

If the electric-field intensity E(10⁹) at which the resistivity of the magnetic carrier comes to 1.0×10⁹ Ω·cm is more than 2.0×10⁴ V/cm, the counter charges can not readily attenuate. As the result, the electric charges of such a magnetic carrier and the electric charges of the toner may attract each other to produce a large adhesion. Hence, it may become hard for the toner to come separated from the carrier, so that the toner can not readily participate in development, resulting in a lowering of image density. Fog or boundary blanks may also occur.

In the present invention, it is also important that the electric-field intensity E(10⁸) at which the resistivity of the magnetic carrier comes to 1.0×10⁸ Ω·cm is set to be from 5.0×10³ V/cm or more to 2.8×10⁴ V/cm or less, which may preferably be from 5.5×10³ V/cm or more to 2.5×10⁴ V/cm or less, and much preferably from 6.0×10³ V/cm or more to 2.0×10⁴ V/cm or less.

Where any data are not present at the electric-field intensity E(10⁸) at which the resistivity of the magnetic carrier comes to 1.0×10⁸ Ω·cm, two points on the side to be extrapolated are connected with a straight line to make extrapolation, and a point at which the straight line drawn by extrapolation and the vertical line at the resistivity 1.0×10⁸ Ω·cm intersect is taken as the electric-field intensity E(10⁸).

Inasmuch as the electric-field intensity E(10⁸) at which the resistivity of the magnetic carrier comes to 1.0×10⁸ Ω·cm is from 5.0×10³ V/cm or more to 2.8×10⁴ V/cm or less, the electric charges may not easily be injected onto the electrostatic latent image bearing member. Hence, the image defects such as halftone coarse images and carrier sticking may not easily occur.

If the electric-field intensity E(10⁸) at which the resistivity of the magnetic carrier comes to 1.0×10⁸ Ω·cm is less than 5.0×10³ V/cm, electric charges may move inside the magnetic carrier at so excessively large level that the electric charges may come to leak onto the electrostatic latent image bearing member or the magnetic carrier may have a low charge providability to the toner. If on the other hand the same is more than 2.8×10⁴ V/cm, the electrostatic adhesion may decrease, but the injection of electric charges onto the electrostatic latent image bearing member tends to occur, so that the electrostatic latent images may come disturbed. Hence, halftone images may come coarse (halftone coarse images). The carrier sticking may also tend to occur.

Thus, in order to settle the subject of the present invention, it is important to simultaneously make control for the attenuation of counter charges coming generated on the surfaces of magnetic carrier particles at the time of development and make control against the easiness in charge injection onto the electrostatic latent image bearing member. It has turned out that the above subject can be settled for the first time when the ratio of the electric-field intensity E(10⁸) to the electric-field intensity E(10⁹), E(10⁸)/E(10⁹), is set to be from 1.0 or more to 5.0 or less.

The ratio of the electric-field intensity E(10⁸) to the electric-field intensity E(10⁹), E(10⁸)/E(10⁹), may preferably be from 1.2 or more to 4.0 or less, and much preferably from 1.5 or more to 3.0 or less.

That is, inasmuch as the ratio of the electric-field intensity E(10⁸) to the electric-field intensity E(10⁹), E(10⁸)/E(10⁹), is set to be from 1.0 or more to 5.0 or less, the image density may less vary over a long period of time and images can be obtained with less fog and halftone coarse images. The boundary blanks and carrier sticking can also be made to less occur. In addition, because of a large change in resistivity for changes in electric-field intensity, a high image density can be secured with ease when an alternating electric field is applied as development bias. In particular, a high image density can be secured even under application of an alternating bias with a low peak-to-peak voltage. Thus, images can be obtained with less variation in image density over a long period of time. Any ring marks may also not easily come because of the low peak-to-peak voltage.

If the ratio of the electric-field intensity E(10⁸) to the electric-field intensity E(10⁹), E(10⁸)/E(10⁹), is more than 5.0, it is difficult to make both control for the attenuation of counter charges coming generated on the surfaces of magnetic carrier particles at the time of development and control against the charge injection onto the electrostatic latent image bearing member. Hence, the image density may vary, and fog or halftone coarse images, boundary blanks and carrier sticking may occur.

To obtain the magnetic carrier the electric-field intensity E(10⁸) and electric-field intensity E(10⁹) of which are within the range of the present invention, it is achievable by changing the specific resistance of the magnetic carrier particles, the state of distribution of a magnetic component and a resin component in the magnetic carrier particles, the state of presence of a resin on the surfaces of the magnetic carrier particles and/or physical properties thereof.

It is also preferable that, in a backscattered electron image of cross sections of the magnetic carrier particles as photographed with a scanning electron microscope, the magnetic core particles (the magnetic component) are each in a sectional-area proportion of from 50 area% or more to 95 area% or less, much preferably from 55 area% or more to 93 area% or less, and particularly preferably from 60 area% or more to 90 area% or less, to the sectional area of the magnetic carrier particles each.

That the magnetic core particles are each in a sectional-area proportion of from 50 area% or more to 95 area% or less is preferable because the magnetic carrier can be made low in specific resistance and made low in magnetic force and stable images can be maintained over a long period of time while preventing toner-spent.

It is preferable that the magnetic core particles are in the sectional-area proportion satisfying the above range as an average value, where it is much preferable that the magnetic carrier particles satisfying the above range are present in a proportion of 60% by number or more of the whole magnetic carrier particles, and particularly preferably 80% by number or more of the whole.

The magnetic core particles may be of bulky form or of porous form, or may be of any other form. Preferably, the magnetic core particles may be porous magnetic core particles. This is preferable for the control of physical properties of the magnetic carrier of the present invention. It is also preferable for the magnetic core particles to have surfaces having unevenness to a certain degree.

The magnetic core particles may further have a specific resistance of from 1.0×10⁶ Ω·cm or more to 5.0×10⁷ Ω·cm or less at 300 V/cm. This is preferable in view of an advantage that the developing performance can be superior and high-quality images can be formed.

A material for the magnetic core particles may include the following: 1) Surface-oxidized iron powder, 2) unoxidized iron powder, 3) particles of metals such as lithium, calcium, magnesium, nickel, copper, zinc, cobalt, manganese, chromium and rare earth elements, 4) alloy particles of any of metals such as iron, lithium, calcium, magnesium, nickel, copper, zinc, cobalt, manganese, chromium and rare earth elements, or oxide particles containing any of these elements, and 5) magnetite particles or ferrite particles.

The ferrite particles refer to a sintered body represented by the following formula:

(M1₂O)ᵤ(M2O)ᵥ(M3₂O₃)_{w}(M4O₂)ₓ(M5₂O₅)_{y}(Fe₂O₃)₂

wherein M1 is a monovalent metal, M2 is a divalent metal, M3 is a trivalent metal, M4 is a tetravalent metal and M5 is a pentavalent metal; and, where u+v+w+x+y+z=1.0, u, v, w, x and y are respectively 0≦(u,v,w,x,y)≦0.8, and z is 0.2<z<1.0.

In the formula, as the M1 to M5, they each represent at least one kind of metallic element selected from the group consisting of Li, Fe, Zn, Ni, Mn, Mg, Co, Cu, Ba, Sr, Ca, Si, V, Bi, In, Ta, Zr, B, Mo, Na, Sn, Ti, Cr, Al, Sc, Y, La, Ce, Pr, Nd, Sm, Eu, Gd, Tb, Dy, Ho, Er, Tm, Yb and Lu. In particular, it is preferable to use any of Li, Mn, Mg, Sr, Cu, Zn, Ni, Co and Ca.

For example, it may include magnetic Li type ferrites [e.g., (Li₂O)ₐ(Fe₂O₃)_{b} (0.0<a<0.4, 0.6≦b<1.0, and a+b=1), Mn type ferrites [e.g., (MnO)ₐ(Fe₂O₃)_{b} (0.0<a<0.5, 0.5≦b<1.0, and a+b=1); Mn—Mg type ferrites [e.g., (MnO)ₐ(MgO)_{b}(Fe₂O₃)_{c} (0.0<a<0.5, 0.0<b<0.5, 0.5—c<1.0, and a+b+c=1)]; Mn—Mg—Sr type ferrites [e.g., (MnO)ₐ(MgO)_{b}(SrO)_{c}(Fe₂O₃)_{d} (0.0<a<0.5, 0.0<b<0.5, 0.0<c<0.5, 0.5≦d<1.0, and a+b+c+d=1)]; and Cu—Zn type ferrites [e.g., (CuO)ₐ(ZnO)_{b}(Fe₂O₃)_{c} (0.0<a<0.5, 0.0<b<0.5, 0.5≦c<1.0, and a+b+c=1)]. The above ferrites show chief elements, and may include those containing any other trace element(s).

In the present invention, ferrites which contain the Mn element are preferred from the viewpoint of the specific resistance of the magnetic core particles and the readiness to control the rate of growth of crystals. For example, the Mn type ferrites, the Mn—Mg type ferrites and the Mn—Mg—Sr type ferrites are preferred.

Production steps for the ferrite particles are described below.

Step 1 (Weighing and Mixing Step)

Ferrite raw materials are weighed out and mixed.

As the ferrite raw materials, usable are oxides, hydroxides, oxalates or carbonates of the above metallic elements.

An apparatus for mixing may include the following: A ball mill, a satellite mill, a jet mill and a vibration mill. In particular, the ball mill is preferred from the viewpoint of mixing performance.

In using the ball mill, ferrite raw materials weighed out and balls are put into the ball mill, and then mixed for from 0.1 hour or more to 20.0 hours or less.

Step 2 (Provisional Baking Step)

The ferrite raw materials thus mixed are provisionally baked at a baking temperature in the range of from 700° C. or more to 1,000° C. or less for from 0.5 hour or more to 5.0 hours or less in the atmosphere to make the raw materials into ferrite. For the baking, the following furnace may be used, for example: A burner type baking furnace, a rotary type baking furnace, or an electric furnace.

Step 3 (Grinding Step)

The provisionally baked ferrite produced in the step 2 is ground by means of a grinder to obtain a finely ground product of provisionally baked ferrite.

There are no particular limitations on the grinder as long as the desired particle diameter can be secured. It may include, e.g., the following: A crusher, a hammer mill, a ball mill, a bead mill, a satellite mill and a jet mill.

In using the ball mill or bead mill, there are no particular limitations on materials for the balls or beads as long as the desired particle diameter can be secured. It may include, e.g., the following: Glass such as soda-lime glass (specific gravity: 2.5 g/cm³), soda-lime-free glass (specific gravity: 2.6 g/cm³) or high-specific gravity glass (specific gravity: 2.7 g/cm³), quartz (specific gravity: 2.2 g/cm³), titania (specific gravity: 3.9 g/cm³), silicon nitride (specific gravity: 3.2 g/cm³), alumina (specific gravity: 3.6 g/cm³), zirconia (specific gravity: 6.0 g/cm³), steel (specific gravity: 7.9 g/cm³) and stainless steel (specific gravity: 8.0 g/cm³). In particular, alumina, zirconia and stainless steel are preferred because of their excellent wear resistance.

There are no particular limitations on the particle diameter of the balls or beads as long as the desired particle diameter can be secured. For example, as the balls, those having a diameter of from 5 mm or more to less than 60 mm may preferably be used. Also, as the beads, those having a diameter of from 0.03 mm or more to less than 5 mm may preferably be used.

The ball mill or bead mill may also preferably be of a wet process because the ground product does not fly up in the mill to achieve a higher grinding efficiency.

Step 4 (Granulation Step)

To the finely ground product of provisionally baked ferrite, water and a binder, and optionally a pore controlling agent, are added to obtain slurry.

As the binder, polyvinyl alcohol may be used, for example.

The pore controlling agent may include a blowing agent and fine resin particles. The blowing agent may include, e.g., sodium hydrogencarbonate, potassium hydrogencarbonate, lithium hydrogencarbonate, ammonium hydrogencarbonate, sodium carbonate, potassium carbonate, lithium carbonate and ammonium carbonate. The fine resin particles may include, e.g., resin fine particles of polyester; polystyrene; styrene copolymers such as a styrene-vinyltoluene copolymer, a styrene-vinylnaphthalene copolymer, a styrene-acrylate copolymer, a styrene-methacrylate copolymer, a styrene-methyl α-chloromethacrylate copolymer, a styrene-acrylonitrile copolymer, a styrene-methyl vinyl ketone copolymer, a styrene-butadiene copolymer, a styrene-isoprene copolymer and a styrene-acrylonitrile-indene copolymer; polyvinyl chloride, phenolic resins, modified phenolic resins, maleic resins, acrylic resins, methacrylic resins, polyvinyl acetate resins, and silicone resins; polyester resins having as a structural unit a monomer selected from aliphatic polyhydric alcohols, aliphatic dicarboxylic acids, aromatic dicarboxylic acids, aromatic dialcohols and diphenols; polyurethane resins, polyamide resins, polyvinyl butyral resins, terpene resins, coumarone indene resins and petroleum resins; and hybrid resins having a polyester unit and a vinyl polymer unit.

The slurry obtained is dried and granulated by using an atomizing drying machine and in a heating atmosphere of from 100° C. or more to 200° C. or less.

As the atomizing drying machine, there are no particular limitations thereon as long as a granulated product having the desired particle diameter can be attained. A spray dryer may be used, for example.

Step 5 (Main Baking Step)

Next, the granulated product of provisionally baked ferrite is baked at a temperature of from 800° C. or more to 1,400° C. or less for from 1 hour or more to 24 hours or less to obtain ferrite particles. The temperature may preferably be from 1,000° C. or more to 1,200° C. or less

Making the baking temperature higher and the baking time longer makes the baking of the granulated product of provisionally baked ferrite proceed, so that crystal growth takes place. This step may be controlled, whereby the magnetic core particles can be made into bulky form or porous form. Baking atmosphere may also be controlled, whereby the specific resistance of the magnetic core particles can be controlled in the preferable range. For example, oxygen concentration may be set low or a reducing atmosphere (in the presence of hydrogen) may be set up, whereby the specific resistance of the magnetic core particles can be made low.

Step 6 (Screening Step)

The particles thus baked are disintegrated, and thereafter may optionally be classified, or sifted with a sieve, to remove coarse particles or fine particles.

In the magnetic core particles thus obtained, in the case of those of porous form, the particles may have a low physical strength, depending on the number and size of pores in the interiors, to tend to break. Accordingly, it is preferable for such porous magnetic core particles to be filled with a resin in at least part of their pores or coated with a resin, to improve the strength required as the magnetic carrier particles. Filling or coating the porous magnetic core particles with a resin also enables control of the resistivity of the magnetic carrier.

As a method of filling the porous magnetic core particles with a resin in their pores, it may include coating methods such as dipping, spraying, brushing and fluidized bed coating.

As the resin with which the porous magnetic core particles are to be filled in their pores, either of a thermoplastic resin and a thermosetting resin may be used, provided that it may preferably be one having a high affinity for the porous magnetic core particles.

The resin with which the porous magnetic core particles are to be filled in their pores may include, as the thermoplastic resin, the following: Polystyrene, polymethyl methacrylate, a styrene-acrylate resin, a styrene-butadiene copolymer, an ethylene-vinyl acetate copolymer, polyvinyl chloride, polyvinyl acetate, polyvinylidene fluoride resin, fluorocarbon resins, perfluorocarbon resins, polyvinyl pyrrolidone, petroleum resins, novolak resins, saturated alkyl polyester resins, polyethylene terephthalate, polybutylene terephthalate, polyarylate, polyamide resins, polyacetal resins, polycarbonate resins, polyether sulfone resins, polysulfone resins, polyphenylene sulfide resins, and polyether ketone resins.

As the thermosetting resin, it may include the following: Phenolic resins, modified phenolic resins, maleic resins, alkyd resins, epoxy resins, unsaturated polyesters obtained by polycondensation of maleic anhydride and terephthalic acid with a polyhydric alcohol, urea resins, melamine resins, urea-melamine resins, xylene resins, toluene resins, guanamine resins, melamine-guanamine resins, acetoguanamine resins, Glyptal resin, furan resins, silicone resins, polyimide resins, polyamide-imide resins, polyether-imide resins and polyurethane resins.

Resins obtained by modifying any of these resins may also be used. In particular, fluorine-containing resins such as polyvinylidene fluoride resin, fluorocarbon resins, perfluorocarbon resins or solvent-soluble perfluorocarbon resins, and modified silicone resins or silicone resins are preferred as having a high affinity for the porous magnetic core particles.

For example, as commercially available products, it may include the following: As silicone resins, KR271, KR255 and KR152, available from Shin-Etsu Chemical Co., Ltd; and SR2400, SR2405, SR2410 and SR2411, available from Dow Corning Toray Silicone Co., Ltd. As modified silicone resins, KR206 (alkyd modified), KR5208 (acryl modified), ES1001N (epoxy modified) and KR305 (urethane modified), available from Shin-Etsu Chemical Co., Ltd; and SR2115 (epoxy modified) and SR2110 (alkyd modified), available from Dow Corning Toray Silicone Co., Ltd.

To obtain the magnetic carrier particles the porous magnetic core particles of which have been filled with the resin in their pores, first a resin solution is readied which is prepared by mixing the resin for filling and a solvent in which the resin is soluble. Thereafter, this resin solution is added to the porous magnetic core particles to make the porous magnetic core particles impregnated with the resin solution, followed by removal of the solvent only. Such a method is preferred.

The solvent used here may be either of an organic solvent and water where the resin for filling is soluble therein. The organic solvent may include toluene, xylene, cellosolve butyl acetate, methyl ethyl ketone, methyl isobutyl ketone, and methanol.

The resin in such a resin solution may preferably be in a solid-matter content of from 1% by mass or more to 50% by mass or less, and much preferably from 1% by mass or more to 30% by mass or less. If a resin solution with a resin content of more than 50% by mass is used, the resin solution itself has a high viscosity, and hence it may be difficult for the resin solution to uniformly fill the pores of the porous magnetic core particles. If on the other hand the resin solution has a resin content of less than 1% by mass, the resin may be in so small content as to come low adherent to the porous magnetic core particles.

The solvent used in the resin solution may preferably be toluene. In a toluene solution having a resin content of 20% by mass, such a resin solution may have a viscosity of from 1.0×10⁻⁶ m²/s or more to 1.0×10⁻³ m²/s or less. Such a case is preferable because the magnetic core particles may readily be filled with the resin.

It is preferable for the magnetic carrier particles in the present invention to have been coated with a resin on their surfaces. In the case when the porous magnetic core particles are used, the particles may be filled with the resin in their pores and thereafter further coated with a resin on their surfaces. Instead, the particles may be coated with a resin on their surfaces without being filled with the resin in their pores. The resin for surface coating may be the same as, or different from, the resin for filling the porous magnetic core particles, and may be either of the thermoplastic resin and the thermosetting resin.

The resin for surface coating may be used alone, or may be used in the form of a mixture of some resins. The thermoplastic resin may also be mixed with a curing agent or the like so as to be cured when used. In particular, it is favorable to use a resin having higher release properties.

The resin for surface coating may further be incorporated with particles having conductivity or particles having charge controllability. The particles having conductivity may include carbon black, magnetite, graphite, zinc oxide and tin oxide.

The particles having charge controllability may include particles of organometallic complexes, particles of organometallic salts, particles of chelate compounds, particles of monoazo metallic complexes, particles of acetylacetone metallic complexes, particles of hydroxycarboxylic acid metallic complexes, particles of polycarboxylic acid metallic complexes, particles of polyol metallic complexes, particles of polymethyl methacrylate resin, particles of polystyrene resin, particles of melamine resins, particles of phenolic resins, particles of nylon resins, particles of silica, particles of titanium oxide and particles of aluminum oxide. The particles having charge controllability may be added in an amount of from 0.5 part by mass or more to 50.0 parts by mass or less, based on 100 parts by mass of the surface coating resin. This is preferable in order to control triboelectric charge quantity.

There are no particular limitations on how to coat the magnetic carrier particles with the resin on their surfaces. A method is available in which the magnetic carrier particles are coated by a coating method such as dipping, spraying, brushing or fluidized bed coating (dry-process coating). In particular, the dipping or dry-process coating is preferred.

The resin with which the surfaces of the magnetic carrier particles are coated may be in an amount of from 0.1 part by mass or more to 5.0 parts by mass or less, based on 100 parts by mass of the particles before coating treatment. This is preferable in order to control triboelectric charge-providing performance.

The magnetic carrier of the present invention may have a 50% particle diameter based on volume distribution (D50) of from 20.0 μm or more to 70.0 μm or less. This is preferable because it can keep carrier sticking from occurring, can keep toner-spent from occurring and can stably be used even in long-term service.

The magnetic carrier of the present invention may have an intensity of magnetization at 1,000/4π (kA/m) of from 40 A /kg or more to 65 A /kg or less. This is preferable in order to improve dot reproducibility, prevent carrier sticking and also prevent toner-spent to obtain stable images.

The magnetic carrier of the present invention may have a true specific gravity of from 3.2 g/cm³ or more to 5.0 g/cm³ or less. This is preferable because it can prevent toner-spent to maintain formation of stable images over a long period of time. It may much preferably have a true specific gravity of from 3.4 g/cm³ or more to 4.2 g/cm³ or less, where it can keep carrier sticking from occurring and can have much superior durability.

The magnetic carrier of the present invention is blended with a toner so as to be used as a two-component developer.

The two-component developer may be used as an initial-stage developer, or may be used as a replenishing developer to be fed to the developing assembly after running.

When used as the initial-stage developer, the toner and the magnetic carrier may preferably be in such a blend proportion that the toner is in an amount of from 2 parts by mass or more to 35 parts by mass or less, and much preferably from 4 parts by mass or more to 25 parts by mass or less, based on 100 parts by mass of the magnetic carrier. Setting their proportion within this range can achieve high image density and can make the toner less scatter.

When used as the replenishing developer, a blend proportion that the toner is in an amount of from 2 parts by mass or more to 50 parts by mass or less, based on 1 part by mass of the magnetic carrier, is preferable from the viewpoint of improvement in running performance of the developer.

In an apparatus in which the replenishing developer is supplied to a developing assembly, it may preferably be so set up that the magnetic carrier that has become excess in the interior of the developing assembly at least is appropriately discharged out of the developing assembly.

As the toner used in the two-component developer, it is preferable that particles having a circle-equivalent diameter of from 0.500 μm or more to less than 1.985 μm as measured with a flow type particle image analyzer having an image processing resolution of 512×512 pixels (0.37 μm×0.37 μm per pixel) (hereinafter also “small-particle toner”) are in a proportion of 30% by number or less.

Such small-particle toner may preferably be in a proportion of 20% by number or less, and much preferably 10% by number or less. Inasmuch as the small-particle toner are in a proportion of 30% by number or less, the carrier and the toner are well blendable in the developer container and also the small-particle toner may less adhere to the magnetic carrier particles. Hence, charge stability of the toner can be retained over a long period of time. The proportion of the small-particle toner may be controlled by how to produce the toner and/or how to classify toner particles.

The toner may also preferably have an average circularity C1 of from 0.940 or more to 1.000 or less for its particles having a circle-equivalent diameter of from 1.985 μm or more to less than 39.69 μm. It is also preferable that average circularity C2 of the particles having a circle-equivalent diameter of from 0.500 μm or more to less than 1.985 μm (small-particle toner) is smaller than the average circularity C1.

Inasmuch as the average circularity C1 of the toner is from 0.940 or more to 1.000 or less, the two-component developer is well transportable on the developer carrying member, and also the toner is well separable from the magnetic carrier particles. Hence, much superior developing performance can be achieved. Also, inasmuch as the C2 is smaller than C1 (C2<C1), the toner may much less stick to the magnetic carrier particles. Hence, the magnetic carrier can maintain stabler charge-providing performance. Also, the toner can have a uniform charge quantity distribution, and can maintain superior developing performance over a long period of time. To control the average circularity, it may be controlled by how to produce the toner and/or how to classify toner particles.

The average circularity of the toner is measured with a flow type particle image analyzer “FPIA-3000 Model” (manufactured by Sysmex Corporation). The principle of measurement therewith is that particles flowing therein are photographed as still images and the images are analyzed. A sample fed to a sample chamber is sent into a flat sheath flow cell by the aid of a sample suction syringe. The sample having been sent into the flat sheath flow cell forms a flat flow in the state it is inserted in sheath solution. The sample passing through the interior of the flat sheath flow cell is kept irradiated with strobe light at intervals of 1/60 second, thus the particles flowing therethrough can be photographed as still images. Also, because of the flat flow, the particles kept flowing can be photographed in a focused state. Particle images are photographed with a CCD camera, and the images photographed are image-processed at an image processing resolution of 512×512 (0.19 μm×0.19 μm per pixel), and the contour of each particle image is extracted, where projected area S and peripheral length L of the particle image are measured.

Next, the projected area S and the peripheral length L are used to determine circle-equivalent diameter. The circle-equivalent diameter refers to the diameter of a circle having the same area as the projected area of the particle image. Circularity C is defined as a value found when the peripheral length of a circle that is found from the circle-equivalent diameter is divided by the peripheral length of particle projected area, and is calculated by using the following expression.

Circularity C=[2×(π×S)^{1/2}]/L.

The circularity is 1 when the particle image is circular. The larger the degree of unevenness of the periphery of the particle image is, the smaller value the circularity has. The circularity of each particle is calculated, and thereafter the arithmetic mean of the circularities thus found is calculated and its value is taken as average circularity.

The toner may also preferably have a weight-average particle diameter (D4) of from 3.0 μm or more to 8.0 μm or less. That the toner has weight-average particle diameter (D4) within this range is preferable because its fluidity in the developing assembly and its coating performance on the developer carrying member can be maintained over a long period of time.

Preferably usable as a binder resin for the toner is a styrene copolymer, a polyester resin, or a hybrid resin having a polyester unit and a styrene polymer unit.

As the binder resin that may be used in the present invention, in order to achieve both storage stability and low-temperature fixing performance of the toner, it may preferably have a peak molecular weight (Mp) of from 2,000 or more to 50,000 or less, a number average molecular weight (Mn) of from 1,500 or more to 30,000 or less and a weight average molecular weight (Mw) of from 2,000 or more to 1,000,000 or less in its molecular weight distribution measured by gel permeation chromatography (GPC), and a glass transition temperature (Tg) of from 40° C. or more to 80° C. or less.

As a wax to be contained in the toner, it may include, e.g., the following: Hydrocarbon waxes such as paraffin wax and Fischer-Tropsch wax; waxes composed chiefly of a fatty ester, such as carnauba wax, behenyl behenate wax and montanate wax; and those obtained by subjecting part or the whole of fatty esters to deoxidizing treatment, such as dioxidized carnauba wax.

The wax may preferably be used in an amount of from 0.5 part by mass or more to 20 parts by mass or less, based on 100 parts by mass of the binder resin. The wax may also preferably be from 45° C. or more to 140° C. or less in peak temperature of its maximum endothermic peak. This is preferable because the toner can achieve both storage stability and hot-offset properties.

As a colorant to be contained in the toner, any known colorant may be used. The colorant may preferably be used in an amount of from 0.1 part by mass or more to 30 parts by mass or less, based on 100 parts by mass of the binder resin.

The toner may optionally be incorporated with a charge control agent. As the charge control agent to be incorporated in the toner, any known one may be used. In particular, an aromatic carboxylic acid metal compound is preferred, which is colorless, makes the toner chargeable at a high speed and can stably maintain a constant charge quantity.

A negative charge control agent may include salicylic acid metal compounds, naphthoic acid metal compounds, dicarboxylic acid metal compounds, polymer type compounds having a sulfonic acid or carboxylic acid in the side chain, polymer type compounds having a sulfonic salt or a sulfonic ester compound in the side chain, polymer type compounds having a carboxylic salt or a carboxylic ester compound in the side chain, boron compounds, urea compounds, silicon compounds, and carixarene. A positive charge control agent may include quaternary ammonium salts, polymer type compounds having such a quaternary ammonium salt in the side chain, guanidine compounds, and imidazole compounds. The charge control agent may internally be added, or may externally be added, to toner particles. The charge control agent may preferably be added in an amount of from 0.2 part by mass or more to 10 parts by mass or less, based on 100 parts by mass of the binder resin.

To the toner, an external additive may preferably be added in order to improve its fluidity. As the external additive, preferred is an inorganic fine powder of silica, titanium oxide or aluminum oxide. It is preferable for the inorganic fine powder to have been made hydrophobic with a silane compound, silicone oil or a mixture of these. The external additive may preferably be used in an amount of from 0.1 part by mass or more to 5.0 parts by mass or less, based on 100 parts by mass of the toner particles.

As processes for producing the toner particles, available are, e.g., a pulverization process, in which the binder resin and the colorant are melt-kneaded and the kneaded product is cooled, followed by pulverization and then classification; a suspension granulation process, in which a solution prepared by dissolving or dispersing the binder resin and the colorant in a solvent is introduced into an aqueous medium to carry out suspension granulation, followed by removal of the solvent; a suspension polymerization process, in which a monomer composition prepared by uniformly dissolving or dispersing the colorant in a monomer is dispersed in a continuous layer (e.g., an aqueous phase) containing a dispersion stabilizer and then polymerization reaction is carried out to produce toner particles; a dispersion polymerization process, in which toner particles are directly produced by using an aqueous organic solvent in which monomers as such are soluble but become insoluble upon formation of polymers or toner particles are directly produced by using an aqueous organic solvent in which monomers are soluble and polymers obtained are insoluble; an emulsion polymerization process, in which toner particles are produced by direct polymerization in the presence of a water-soluble polar polymerization initiator; and an emulsion agglomeration process, in which toner particles are obtained through at least the step of agglomerating fine polymer particles and fine colorant particles to form a fine-particle agglomerate and the step of ripening to cause fusion between fine particles in the fine-particle agglomerate.

A procedure for producing the toner by pulverization is described below.

In the step of mixing raw materials, as materials making up toner particles, the binder resin, the colorant, the wax and optionally other component(s) such as the charge control agent, for example, are weighed in stated quantities and are compounded and mixed.

Next, the materials thus mixed are melt-kneaded to disperse the colorant and so forth in the binder resin. In this melt kneading step, a batch-wise kneader or a continuous type kneader may be used. Single-screw or twin-screw extruders are prevailing because of an advantage of enabling continuous production.

Further, a colored resin composition obtained by the melt kneading may be rolled out by means of a twin-roll mill or the like, followed by cooling through a cooling step by using water or the like.

Then, the cooled product of the resin composition is pulverized in the pulverization step into a product having the desired particle diameter. In the pulverization step, the product is coarsely ground by means of a grinding machine, and thereafter finely pulverized by means of a fine-grinding machine. Thereafter, the pulverized product obtained may optionally be classified by using a classifier or a sifting machine, thus the toner particles are obtained. After the pulverization, the product may also optionally be subjected to treatment for surface modification such as treatment for making spherical.

Where the toner particles are produced by polymerization, any known monomers may be used which are used in obtaining styrene copolymers.

As a polymerization initiator used in polymerizing the monomers, an azo type polymerization initiator or a peroxide type polymerization initiator may be used.

The polymerization initiator may commonly be used in an amount of from 0.5 to 20% by mass based on the mass of the polymerizable monomer, which may vary depending on the intended degree of polymerization. The polymerization initiator may a little vary in type depending on methods for polymerization, and may be used alone or in the form of a mixture, making reference to its 10-hour half-life period temperature. In order to control the degree of polymerization, any known cross-linking agent, chain transfer agent, polymerization inhibitor and so forth may further be added and used.

In the case when suspension polymerization is used as the toner production process, a dispersant may be used. As the dispersant, any known inorganic oxide compound or organic compound may be used. Such a dispersant is used in the state it has been dispersed in an aqueous phase. The dispersant may preferably be mixed in an amount of from 0.2 to 10.0 parts by mass based on 100 parts by mass of the monomer.

As the dispersant, those commercially available may be used as they are. In order to obtain dispersed particles having a fine and uniform particle size, however, the inorganic compound may be formed in a dispersion medium under high-speed stirring. For example, in the case of tricalcium phosphate, an aqueous sodium phosphate solution and an aqueous calcium chloride solution may be mixed under high-speed stirring, whereby a dispersant much preferable for the suspension polymerization can be obtained. A surface active agent may also be used in an amount of from 0.001 to 0.1 part by mass based on 100 parts by mass of the monomer.

The image forming method of the present invention is described next.

An example of an image forming apparatus making use of the image forming method of the present invention is shown in FIG. 2. In what is shown in FIG. 2, a photosensitive member 12 that is an electrostatic latent image bearing member is rotated in the direction of an arrow shown in the drawing. The photosensitive member 12 is electrostatically charged by means of a charging assembly 13 that is a charging means. The surface of the photosensitive member 12 thus charged is exposed to light by means of an exposure unit 14 that is an electrostatic latent image forming means, to form an electrostatic latent image. A developing assembly 15 has a developer container holding therein the two-component developer. A developer carrying member (developing sleeve) 16 is disposed in a rotatable state, and also internally provided with magnets 17 as an electric-field generating means in the interior of the developer carrying member 16. At least one of the magnets is set at the position facing the photosensitive member 12. The two-component developer is held on the developer carrying member 16 by the aid of a magnetic field of the magnets and, after the level of the two-component developer thereon has been controlled by a control member 18, transported to a developing zone facing the photosensitive member 12. At the developing zone, a magnetic brush is formed by the aid of a magnetic field generated by any of the magnets 17.

Thereafter, a development bias formed by superimposing an alternating electric field on a direct-current electric field is applied to the part between the photosensitive member 12 and the developer carrying member 17, whereby the electrostatic latent image is rendered visible as a toner image. The toner image formed on the photosensitive member 12 is electrostatically transferred to a transfer material 23 by means of a transfer charging assembly 20. In this transfer step, the apparatus may be so set up that the toner image is first transferred from the photosensitive member 12 to an intermediate transfer member and then transferred to the transfer material 23. Thereafter, this transfer material 23 is transported to a fixing assembly 21, where the toner image is fixed onto the transfer material 23 by the action of heat and pressure. Thereafter, this transfer material 23 is delivered out of the apparatus as a reproduced image. Here, after the transfer step, the toner having remained on the photosensitive member 12 is removed by a cleaner 22. Thereafter, the photosensitive member 12 having been cleaned by the cleaner 22 is electrically initialized by light irradiation from a pre-exposure unit 24, and the above operation of image formation is repeated.

Steps in the image forming method of the present invention are described here.

Charging Step

As the charging means used in the charging step, there are no particular limitations thereon as long as it is a means by which the surface of the electrostatic latent image bearing member is provided with electric charges to charge the electrostatic latent image bearing member electrostatically. Usable as the charging means are an assembly which charges the electrostatic latent image bearing member electrostatically in non-contact with the electrostatic latent image bearing member as in a corona charging means, and an assembly which charges the electrostatic latent image bearing member electrostatically by bringing a conductive roller or blade into contact with the electrostatic latent image bearing member.

Exposure Step

In the exposure step, any known exposure unit may be used as an exposure means. For example, a semiconductor laser or a light-emitting diode is used as a light source, and a scanning optical unit may be used which is made up of a polygon mirror, a lens and a mirror.

Developing Step

In the developing step, the magnetic brush is formed on the developer carrying member by the use of the two-component developer of the present invention, and the magnetic brush is brought into contact with the electrostatic latent image bearing member, in the state of which the development bias formed by superimposing an alternating electric field on a direct-current electric field is applied to the part between the electrostatic latent image bearing member and the developer carrying member (SD gap) to develop the electrostatic latent image by the use of the toner.

The magnets provided in the interior of the developer carrying member may have a magnetic flux density of from 60 mT or more to 150 mT or less. This is preferable in order to form the magnetic brush on the developer carrying member by the use of the two-component developer.

The SD gap may have a distance of 50 μm or more to 150 μm or less, and usually of about 300 μm. This is preferable in view of the developing performance of the toner and the prevention of carrier sticking.

The alternating electric field may be formed at a peak-to-peak voltage (Vpp) of from 0.5 kV or more to 2.0 kV or less, a frequency of 1.0 kHz or more to 3.0 kHz or less. This is preferable in order to achieve high image quality. It is preferable for the Vpp to be made low as far as possible. When it is made low, a very low developing performance may result. When the Vpp is made high, a sufficient developing performance is achievable, but on the other hand a discharge phenomenon may occur because of a too high electric-field intensity to cause the phenomenon that ring-like or spot-like patterns (called ring marks) appear on transfer materials. The ring marks lowers the Vpp, and can be prevented where the discharge phenomenon is avoidable. Accordingly, it is preferable to perform development at a lower Vpp that may cause no ring marks. The peak-to-peak voltage (Vpp) of the alternating electric field may preferably be 1.5 kV or less, and much preferably 1.3 kV or less.

The use of the magnetic carrier of the present invention enables achievement of a high developing performance, and hence a high image density can be maintained even at such a low Vpp. It can also make carrier sticking and ring marks less occur.

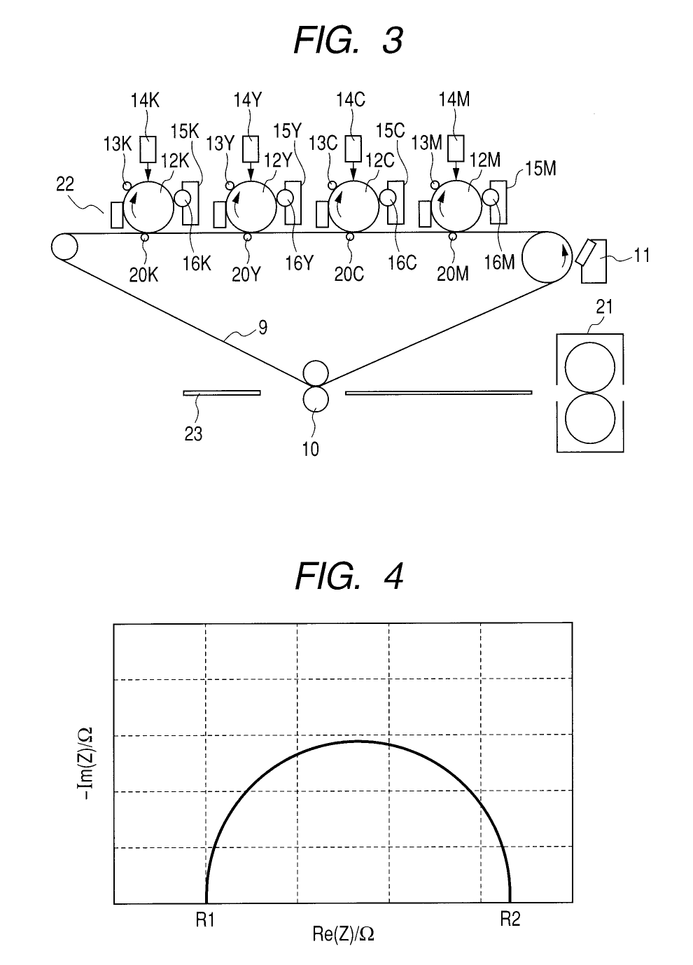

FIG. 3 is a schematic view of an example in which the image forming method of the present invention is applied to a full-color image forming apparatus.

The arrangement of image forming units shown by K, Y, C and M in the drawing and the rotational directions shown by arrows are by no means limited to these. In this connection, K denotes black, Y yellow, C cyan and M magenta. In FIG. 3, photosensitive members 12K, 12Y, 12C and 12M that are electrostatic latent image bearing members are rotated in the directions of arrows shown in the drawing. The photosensitive members are electrostatically charged by means of charging assembles 20K, 20Y, 20C and 20M, respectively, that are charging means. The surfaces of the electrographic photosensitive members thus charged are exposed to light by means of exposure units 14K, 14Y, 14C and 14M, respectively, that are electrostatic latent image forming means, to form electrostatic latent images. Thereafter, the electrostatic latent images are rendered visible as toner images by the use of two-component developers (not shown) held on developer carrying members 16K, 16Y, 16C and 16M provided in developing assemblies 15K, 15Y, 15C and 15M, respectively, that are developing means. The toner images are further transferred to an intermediate transfer member 9 by means of transfer assemblies 20K, 20Y, 20C and 20M that are transfer means. The toner images thus transferred are further transferred to a transfer material 23 by means of a transfer assembly 10 that is a transfer means, and this transfer material 23 is transported to a fixing assembly 21 that is a fixing means, where the toner image is fixed by the action of heat and pressure, and reproduced as an image. Then, reference numeral 11 denotes a cleaning member of the intermediate transfer member 9, which collects transfer residual toners and so forth.

How to measure various physical properties of the magnetic carrier and toner described above is described below.

Measurement of Dynamic Impedance

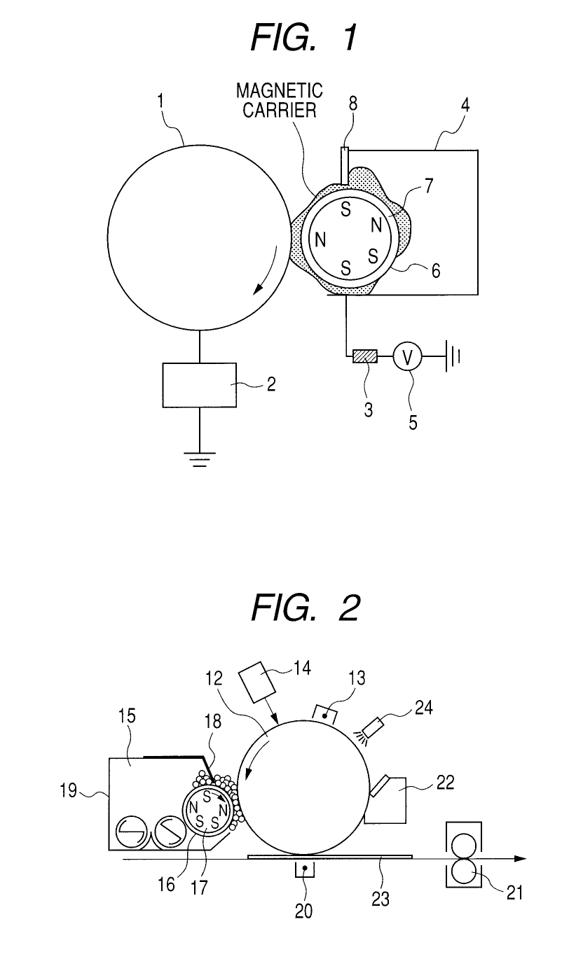

How to measure the resistivity ρ is described. FIG. 1 is a schematic view of an instrument used for the measurement.

In the measurement of dynamic impedance, a developing assembly used in a full-color copying machine imagePRESS C1, manufactured by CANON INC., is converted in the following way to make measurement. Stated specifically, the space for a blade 8 made of SUS stainless steel is so controlled that the carrier level on a developing sleeve 6 may be 30 mg/cm².

A cylindrical member 1 made of aluminum (hereinafter “Al drum 1”) of 60 mm in diameter and the developing sleeve 6, made of SUS stainless steel, are set face to face leaving a distance (SD gap) of 300 μm between them. Then, the Al drum 1 and the developing sleeve 6 are rotated at a peripheral speed of 300 mm/sec and a peripheral speed of 540 mm/sec, respectively, in the same direction at the position where they face each other. Herein, a conversion machine of the developing assembly of the full-color copying machine imagePRESS Cl, manufactured by CANON INC., is used to make measurement, which, however may be another apparatus as long as it can be set under the above conditions. The materials for the blade and developing sleeve may also be aluminum. In that state, an AC voltage to be measured is applied across the Al drum 1 and the developing sleeve 6 from a power source 5 (HVA4321, manufactured by NF Corporation). In the present measurement, the AC voltage outputted from the power source for measuring dynamic impedance is applied to the developing sleeve 6 through a protective resistance 3 of 10 kΩ for measuring dynamic impedance. Providing the protective resistance 3 for measuring dynamic impedance can prevent the measuring instrument from being broken because of the flowing of any excess current such as leakage current across the cylindrical member 1 made of aluminum for measuring dynamic impedance and the developing sleeve 6.

At this point, the frequency of sine waves is swept from 1 Hz to 10 kHz, and the electric current of response to effective voltage is measured. The impedance is measured in this way, and the data obtained may be analyzed by analytical software to find the resistivity ρ. In the present invention, the AC voltage is changed from 100 V to 1,000 V at intervals of 100 V, where any dependence on electric-field intensity is measured.

Electric-field intensity (V/cm)=effective voltage (V)/SD gap (cm).

The impedance is measured with a dielectric measuring system 2 (126096W Series, manufactured by Solartron Public Company Limited, U.K.) in an automatic mode. A method of analysis is described here. SMaRT Ver. 2.7.0, an attachment to the instrument, is used to control the measuring instrument and analyze the measured data. By using this software, complex impedance Z (ω) corresponding to frequency, expressed by the following equation, may be measured from AC voltage having the stated frequency and from electric current corresponding thereto.

Z (ω)=Re[Z(ω)]+iIm[Z(ω)]

wherein Re(Z) is the real part of impedance, Im(Z) is the imaginary part of impedance, and ω's are each frequency.

An equivalent circuit is derived out of Cole-Cole plot (FIG. 4) set up by plotting respective measured values [Re(Z) and Im(Z)] when the frequency is swept from 1 Hz to 10 kHz. Where the Cole-Cole plot is semicircular as shown in FIG. 4, it suggests that the equivalent circuit of the magnetic carrier is a parallel RC (resistance-capacitance) circuit. Using analytical software (ZView Ver. 2.90) which is an attachment to the instrument, the data may be fitted with the parallel RC circuit to find resistance Rp (Ω) of the magnetic carrier.

The resistivity ρ (Ω·cm) of the magnetic carrier is found from the resistance Rp (Ω) of the magnetic carrier as found by the above analytical method, the SD gap (cm) and the area (cm²) of contact of the magnetic carrier with the Al drum 1.

Resistivity ρ (Ω·cm)=resistance Rp (Ω)×contact area (cm²)/SD gap (cm).

To measure the contact area, the distance of contact of the magnetic brush with the Al drum at the development zone is observed on a video microscope.

Contact area (cm²)=contact distance (cm) of magnetic brush in the peripheral direction×contact distance (cm) of magnetic brush in the lengthwise direction.

Backscattered Electron Image of Cross Sections of Magnetic Carrier Particles

In cross-sectional processing of the magnetic carrier particles, a focused ion beam (FIB) processing observation instrument FB-2100 (manufactured by Hitachi Ltd.) is used. A sample stand for FIB is coated thereon with a carbon paste, and magnetic carrier particles are made to stick thereon in a small quantity in such a way that the particles are one by one independently present, where platinum is vacuum-deposited as a conductive film to prepare a sample. The sample is set on the FIB instrument, and is roughly processed (beam current: 39 nA) at an accelerating voltage of 40 kV and using a Ga ionic source, subsequently followed by finish processing (beam current: 7 nA) to cut out sample cross sections.

Here, the magnetic carrier particles used as the sample are magnetic carrier particles having D50×0.9≦Dmax≦D50×1.1 as maximum diameter Dmax of each sample, which are taken as an object of measurement. The Dmax is defined to be the maximum diameter found when the sample with carrier particles made to stick are observed in the vertical direction as viewed from the sample-stuck surface.

Further, the position of a plane inclusive of maximum length that is in the direction parallel to each sample-stuck surface is taken as distance h from the sample-stuck surface (e.g., in the case of a perfect sphere having radius r, it comes that h=r). Then, the cross sections are cut out within the range of from 0.9×h or more to 1.1×h or less, in the direction parallel to the sample-stuck surface.

The samples thus cross-section processed may be used as it is, for the observation on a scanning electron microscope (SEM). The emission level of backscattered electrons depends on the atomic numbers of materials constituting the sample, from the fact of which compositional images of cross sections of the magnetic carrier particles can be obtained. In the observation of cross sections of the magnetic carrier particles of the present invention, it is made using a scanning electron microscope (SEM) S-4800, manufactured by Hitachi Ltd., at an accelerating voltage of 2.0 kV.

About a gray-scale SEM backscattered electron image of cross sections of the magnetic carrier particles, calculation is made by the following procedure and using image analytical software Image-Pro Plus (available from Media Cybernetics, Inc.).

A processed cross section region of a magnetic carrier particle is beforehand designated on the image. About the processed cross section region thus designated, it is made into a gray-scale image with 256 gradations. This image is divided thereon into three regions as a region of void portions for 0 to 19 gradations from the lower place of gradation values, a region of resin portions for 20 to 129 gradations and a region of magnetic-core portions for 130 to 254 gradations. The 255th gradation is taken as a background portion outside the processed cross section region. In the method of measuring the area proportion of the magnetic core portion at the cross section of the magnetic carrier particle, the processed cross section region of the magnetic carrier particle is beforehand designated on the image, and is taken as the sectional area of the magnetic carrier particle. The area held by the magnetic core portion is divided by the sectional area of the magnetic carrier particle, and the value found is taken as “sectional-area proportion (area %) of magnetic core portion”. In the present invention, the like measurement is made on 20 magnetic carrier particles chosen at random, and an average value on these is used.

Measurement of Specific Resistance of Magnetic Core Particles

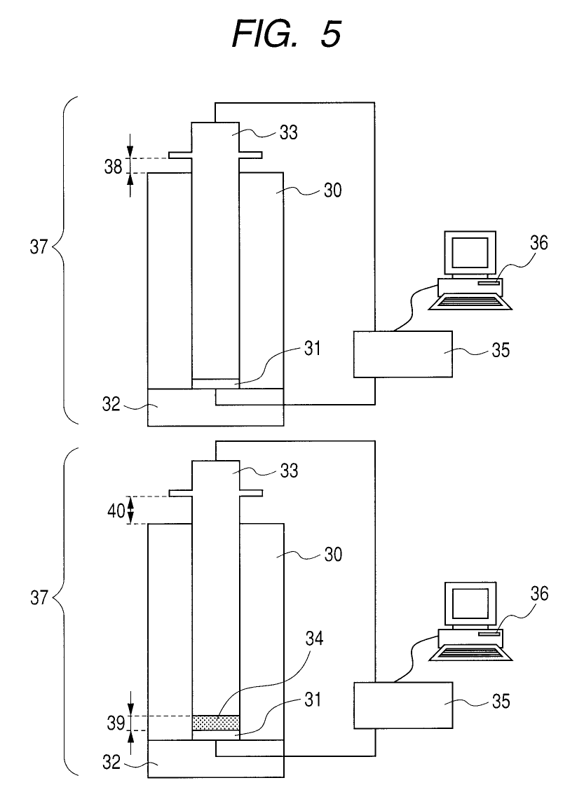

The specific resistance of the magnetic core particles may be measured with a measuring instrument schematically shown in FIG. 5. In the measurement for the magnetic core particles, measurement is made by using a sample standing not provided with any resin.

A resistance measuring cell A is constituted of a cylindrical PTFE resin container 30 in which a hole of 2.4 cm² in cross-sectional area is made, a lower electrode (made of stainless steel) 31, a supporting pedestal (made of PTFE resin) 32 and an upper electrode (made of stainless steel) 33. The cylindrical PTFE resin container 30 is put on the supporting pedestal 32, a sample (magnetic core particles) 34 is put into it in an amount ranging approximately from 0.5 g to 1.3 g, and the upper electrode is placed on the sample 34 put into it, where the thickness of the sample is measured. Where the thickness measured when there is no sample is represented by d1 (blank: 38 in FIG. 5) and the thickness measured when the sample has been put into the container in the amount of approximately from 0.5 g to 1.3 g is represented by d2 (sample; 40 in FIG. 5), actual thickness d (39 in FIG. 5) of the sample is found by using the following expression:

d=d2(sample)−d1(blank).

At this point, it is important to appropriately change the amount of the sample in such a way that the sample may be in a thickness of 0.95 mm or more to 1.04 mm.

A DC voltage is applied across the electrodes, and electric current flowing at that point may be measured to find the specific resistance of the magnetic core particles. In the measurement, an electrometer 35 (e.g., KEITHLEY 6517A, manufactured by Keithley Instruments Inc.) and a controlling computer 36 are used.

Control by the controlling computer is performed by using a control system produced by National Instruments Corporation and control software (LabVEIW, produced by National Instruments Corporation). As conditions for measurement, an actually measured value d is so inputted that contact area S between the sample and the electrodes is 2.4 cm² and the sample is from 0.95 mm ore more to 1.04 mm or less in thickness. Also, the load to the upper electrode is set at 120 g, and maximum applied voltage, 1,000 V.

As conditions for voltage application, an IEEE-488 interface is used between the controlling computer and the electrometer, and automatic ranging function of the electrometer is utilized. Stated specifically, screening is performed in which voltages of 1 V, 2 V, 4 V, 8 V, 16 V, 32 V, 64 V, 128 V, 256 V, 512 V and 1,000 V are applied for 1 second for each. In that course, the electrometer judges whether or not the voltage is applicable up to 1,000 V/cm at the maximum (as electric-field intensity, about 10,000 V/cm) at the maximum. If any excess current flows, “VOLTAGE SOURCE OPERATE” blinks. Then, the instrument lowers the voltage to further screen any applicable voltage to automatically decide the maximum value of applied voltages.

Thereafter, main measurement is performed. The maximum voltage value obtained is divided into five (5) values, and the resultant voltages are retained for 30 seconds for each step, where, from the electric-current values found thereafter, resistance values are measured. For example, where the maximum applied voltage is 1,000 V, voltages are applied in such an order that the voltage is raised and thereafter dropped at intervals of 200 V, i.e., in the order of 200 V, 400 V, 600 V, 800 V, 1,000 V, 1,000 V, 800 V, 600 V, 400 V and 200 V, which are retained for 30 seconds in the respective steps, where, from the electric-current values found thereafter, resistance values are measured. Also, where the maximum applied voltage is 66.0 V, voltages are applied in the order of 13.2 V, 26.4 V, 39.6 V, 52.8 V, 66.0 V, 66.0 V, 52.8 V, 39.6 V, 26.4 V and 13.2 V. Electric-current values found there are processed on the computer to calculate the electric-field intensity and specific resistance from sample thickness and electrode area, and the results obtained are plotted on a graph. In that case, five points are plotted at which the voltage is dropped from the maximum applied voltage. Here, in the measurement at each step, when “VOLTAGE SOURCE OPERATE” blinks and any excess current flows, the resistance value is displayed as 0 on measurement. The specific resistance and the electric-field intensity are found by using the following expressions.

Specific resistance (Ω·cm)=[applied voltage (V)/measured electric current (A) ]×S(cm)/d(cm).

Electric-field intensity (V/cm)=applied voltage (V)/d(cm).

How to Measure Resin Viscosity

As the viscosity, viscosity after 60 seconds is measured by VP-500, manufactured by HAAKE Co. Measuring instrument and conditions are as shown below.
Viscometer: Rotational viscometer, Viscotester VT550 (manufactured by HAAKE Co.).
Sensor system: NV cup/NV rotor.
Number of revolutions: 8.3 s⁻¹ (500 rpm).
Circulating thermostatic chamber: Open Bath Circulator DC5-K20 (manufactured by HAAKE Co.).
Preset temperature: 25° C.

How to measure 50% particle diameter based on volume distribution (D50) of magnetic carrier particles

Particle size distribution is measured with a laser diffraction-scattering particle size distribution measuring instrument “MICROTRACK MT3300EX” (manufactured by Nikkiso Co. Ltd.).

In the measurement of the 50% particle diameter based on volume distribution (D50) of the finely ground product of provisionally baked ferrite, “Sample Delivery Control (SDC)” (manufactured by Nikkiso Co. Ltd.), which is a sample circulator for wet-process measurement, is attached to make the measurement. The provisionally baked ferrite is so dropped into the sample circulator as to be in measurement concentration. Flow rate was set at 70%; ultrasonic output, 40 W; and ultrasonic time, 60 seconds.

Measurement conditions are as follows:
Set Zero time: 10 seconds.
Measurement time: 30 seconds.
Number of time for measurement: 10 times.
Solvent diffraction index: 1.33.
Particle diffraction index: 2.42.
Particle shape: Non-spherical.
Measurement upper limit: 1,408 μm.
Measurement lower limit: 0.243 μm.
Measurement environment: About 23° C./50% RH.

In the measurement of the 50% particle diameter based on volume distribution (D50) of the magnetic carrier particles, “One-shot Drying Sample Conditioner TURBOTRAC” (manufactured by Nikkiso Co. Ltd.), which is a sample feeder for dry-process measurement, is attached to make the measurement. As feed conditions of TURBOTRAC, a dust collector is used as a vacuum source, setting air flow at about 33 liters/second and pressure at about 17 kPa. Control is automatically made on software. As particle diameter, 50% particle diameter (D50) is found, which is the volume-base cummulative value. Control and analysis are made using attached software (Version 10.3.3-202D).

Measurement conditions are as follows:
Set Zero time: 10 seconds.
Measurement time: 10 seconds.
Number of time for measurement: One time.
Particle diffraction index: 1.81.
Particle shape: Non-spherical.
Measurement upper limit: 1,408 μm.
Measurement lower limit: 0.243 μm.
Measurement environment: About 23° C./50% RH.

How to Measure Intensity of Magnetization of Magnetic Carrier

The intensity of magnetization of the magnetic carrier may be measured with a vibrating magnetic-field type magnetic-property measuring instrument (Vibrating Sample Magnetometer) or a direct-current magnetization characteristics recording instrument (B-H Tracer). In Examples given later, it is measured with a vibration magnetic-field type magnetic-property measuring instrument BHV-30 (manufactured by Riken Denshi Co., Ltd.) by the following procedure.

A cylindrical plastic container is well densely filled with the carrier, and this is used as a sample. Actual mass of the carrier with which the container has been filled is measured. Thereafter, the magnetic carrier particles in the plastic container are bonded with an instantaneous adhesive so that the sample may not move.

The axis of external magnetic field at 5,000/4π (kA/m) and the axis of magnetic moment are corrected by using a standard sample.

Sweep rate is set at 5 min/loop, and the intensity of magnetization is measured from the loop of magnetic moment under application of an external magnetic field of 1,000/4π (kA/m). The value thus obtained is divided by the mass of the sample to find the intensity of magnetization (Am/kg) of the carrier.

How to Measure True Specific Gravity of Magnetic Carrier:

The true specific gravity of the magnetic carrier is measured with a dry automatic densitometer ACCUPYC 1330 (manufactured by Shimadzu Corporation). First, a sample having been left for 24 hours in an environment of 23° C./50% RH is precisely weight in an amount of 5 g. This is put into a measuring cell (10 cm³), and then inserted to a main-body sample chamber. Measurement may be made by automatic measurement by starting the measurement after sample mass is inputted to the main body.

As a measurement condition for the automatic measurement, helium gas having been controlled at 20.000 psig (2.392×10² kPa) is used. A condition in which, after the interior of the sample chamber is purged 10 times therewith, the change in pressure in the interior of the sample chamber comes to be 0.005 psig/min (3.447×10⁻² kPa/min) is regarded as an equilibrium condition. Its interior is repeatedly purged with the helium gas until it comes into the equilibrium condition. The pressure in the interior of the main-body sample chamber at the time of equilibrium condition is measured. The sample volume can be calculated from the change in pressure at the time of having reached such equilibrium condition (the Boyle low). Since the sample volume can be calculated, the true specific gravity of the sample may be calculated by using the following expression.

True specific gravity (g/cm³) of sample=sample mass (g)/sample volume (cm³).

An average value of the values measured repeatedly five times by this automatic measurement is taken as the true specific gravity (g/cm³) of the magnetic carrier and magnetic core particles.

Measurement of proportion of small particles (particles having circle-equivalent diameter of from 0.500 μm or more to less than 1.985 μm) in toner, and average circularity of toner

The proportion of small particles in the toner and the average circularity of the toner are measured with a flow type particle image analyzer “FPIA-3000 Model” (manufactured by Sysmex Corporation) on the basis of conditions of measurement and analysis made in operating the corrections.

A specific way of measurement is as follows: First, about 20 ml of ion-exchanged water, from which impurity solid matter and the like have beforehand been removed, is put into a container made of glass. To this water, about 0.2 ml of a dilute solution is added as a dispersant, which has been prepared by diluting “CONTAMINON N” (an aqueous 10% by mass solution of a pH 7 neutral detergent for washing precision measuring instruments which is composed of a nonionic surface-active agent, an anionic surface-active agent and an organic builder and is available from Wako Pure Chemical Industries, Ltd.) with ion-exchanged water to about 3-fold by mass. Further, about 0.02 g of a measuring sample is added, followed by dispersion treatment for 2 minutes by means of an ultrasonic dispersion machine to prepare a liquid dispersion for measurement. In that course, the dispersion system is appropriately so cooled that the liquid dispersion may have a temperature of 10° C. or more to 40° C. or less. As the ultrasonic dispersion machine, a desk-top ultrasonic washer dispersion machine of 50 kHz in oscillation frequency and 150 W in electric output (e.g., “VS-150”, manufactured by Velvo-Clear Co.) is used. Into its water tank, a stated amount of ion-exchanged water is put, and about 2 ml of the above CONTAMINON N is fed into this water tank.

In the measurement, the flow type particle image analyzer is used, having a standard objective lens (10 magnifications), and Particle Sheath “PSE-900A” (available from Sysmex Corporation) is used as a sheath solution. The liquid dispersion having been controlled according to the above procedure is introduced into the flow type particle analyzer, where 3,000 toner particles are counted in an HPE measuring mode and in a total count mode. Then, the binary-coded threshold value at the time of particle analysis is set to 85%.

Here, the range of diameters of particles to be analyzed may be limited to determine the number proportion (%) of the particles within that range and the average circularity. For example, where the number proportion (%) of particles having circle-equivalent diameter of from 0.500 μm or more to less than 1.985 μm and the average circularity are determined, the range of diameters of particles to be analyzed may be limited to circle-equivalent diameter of from 0.500 μm or more to less than 1.985 μm.

In the measurement, before the measurement is started, autofocus control is performed using standard latex particles (e.g., “RESEARCH AND TEST PARTICLES Latex Microsphere Suspensions 5200A”, available from Duke Scientific Corporation). Thereafter, the autofocus control may preferably be performed at intervals of 2 hours after the measurement has been started.

In Examples of the present invention, a flow type particle image analyzer was used on which correction was operated by Sysmex Corporation and for which a correction certificate issued by Sysmex Corporation was issued. Measurement was made under the measurement and analysis conditions set when the correction certificate was received, except that the diameters of particles to be analyzed were limited to the circle-equivalent diameter of from 0.500 μm or more to less than 1.985 μm or from 1.985 μm or more to less than 39.69 μm.

How to Measure Weight Average Particle Diameter (D4) of Toner

The weight average particle diameter (D4) of the toner is measured by using a precision particle size distribution measuring instrument “Coulter Counter Multisizer 3” (registered trademark; manufactured by Beckman Coulter, Inc.), which has an aperture tube of 100 μm in size and employing the aperture impedance method, and software “Beckman Coulter Multisizer 3 Version 3.51” (produced by Beckman Coulter, Inc.), which is attached to Multisizer 3 for its exclusive use in order to set the conditions for measurement and analyze the data of measurement. The measurement is made through 25,000 channels as effective measuring channels in number, and the data of measurement are analyzed to make calculation.

As an aqueous electrolytic solution used for the measurement, a solution may be used which is prepared by dissolving guaranteed sodium chloride in ion-exchanged water in a concentration of about 1% by mass, e.g., “ISOTON II” (available from Beckman Coulter, Inc.).

Before the measurement and analysis are made, the software for exclusive use is set in the following way. On a “Change of Standard Measuring Method (SOM)” screen of the software for exclusive use, the total number of counts of a control mode is set to 50,000 particles. The number of time of measurement is set to one time and, as Kd value, the value is set which has been obtained using “Standard Particles, 10.0 μm” (available from Beckman Coulter, Inc.). Threshold value and noise level are automatically set by pressing “Threshold Value/Noise Level Measuring Button”. Then, current is set to 1,600 μA, gain to 2, and electrolytic solution to ISOTON II, where “Flash for Aperture Tube after Measurement” is checked.

On a “Setting of Conversion from Pulse to Particle Diameter” screen of the software for exclusive use, the bin distance is set to logarithmic particle diameter, the particle diameter bin to 256 particle diameter bins, and the particle diameter range to from 2 μm or more to 60 μm or less.

A specific way of measurement is as follows:

(1) About 200 ml of the aqueous electrolytic solution is put into a 250 ml round-bottomed beaker made of glass for exclusive use in Multisizer 3, and this is set on a sample stand, where stirring with a stirrer rod is carried out at 24 revolutions/second in the anticlockwise direction. Then, a “Flash of Aperture” function of the analytical software is operated to beforehand remove any dirt and air bubbles in the aperture tube.

(2) About 30 ml of the aqueous electrolytic solution is put into a 100 ml flat-bottomed beaker made of glass. To this water, about 0.3 ml of a dilute solution is added as a dispersant, which has been prepared by diluting “CONTAMINON N” (an aqueous 10% by mass solution of a pH 7 neutral detergent for washing precision measuring instruments which is composed of a nonionic surface-active agent, an anionic surface-active agent and an organic builder and is available from Wako Pure Chemical Industries, Ltd.) with ion-exchanged water to 3-fold by mass.

(3) An ultrasonic dispersion machine of 120 W in electric output “Ultrasonic Dispersion system TETORA 150” (manufactured by Nikkaki Bios Co.) is readied, having two oscillators of 50 kHz in oscillation frequency which are built therein in the state their phases are shifted by 180 degrees. Into its water tank, a stated amount of ion-exchanged water is put, and about 2 ml of the above CONTAMINON N is added to the water in this water tank.

(4) The beaker of the above (2) is set to a beaker fixing hole of the ultrasonic dispersion machine, and the ultrasonic dispersion machine is set working. Then, the height position of the beaker is so adjusted that the state of resonance of the aqueous electrolytic solution surface in the beaker may become highest.

(5) In the state the aqueous electrolytic solution in the beaker of the above (4) is irradiated with ultrasonic waves, about 10 mg of the toner is little by little added to the aqueous electrolytic solution and is dispersed therein. Then, such ultrasonic dispersion treatment is further continued for 60 seconds. In carrying out the ultrasonic dispersion treatment, the water temperature of the water tank is appropriately so controlled as to be 10° C. or more to 40° C. or less.

(6) To the round-bottomed beaker of the above (1), placed inside the sample stand, the aqueous electrolytic solution in which the toner has been dispersed in the above (5) is dropwise put in by using a pipette, and the measuring concentration is so adjusted as to be about 5%. Then the measurement is made until the measuring particles come to 50,000 particles in number.

(7) The data of measurement are analyzed by using the above software attached to the measuring instrument for its exclusive use, to calculate the weight average particle diameter (D4). Here, “Average Diameter” on an “Analysis/Volume Statistic Value (Arithmetic Mean)” screen when set to graph/% by volume in the software for exclusive use is the weight average particle diameter (D4).

How to measure peak molecular weight (Mp), number average molecular weight (Mn) and weight average molecular weight (Mw) of resin or toner

The peak molecular weight (Mp), number average molecular weight (Mn) and weight average molecular weight (Mw) are measured by gel permeation chromatography (GPC) in the following way.

First, a sample is dissolved in tetrahydro-furan (THF) at room temperature over a period of 24 hours. The binder resin or toner is used as the sample. Then, the solution obtained is filtered with a solvent-resistant membrane filter “MAISHORIDISK” (available from Tosoh Corporation) of 0.2 μm in pore diameter to make up a sample solution. Here, the sample solution is so controlled that the component soluble in THF is in a concentration of about 0.8% by mass. Using this sample solution, the measurement is made under the following conditions.
Instrument: HLC8120 GPC (detector: RI) (manufactured by Tosoh Corporation).
Columns: Combination of seven columns, Shodex KF-801, KF-802, KF-803, KF-804, KF-805, KF-806 and KF-807 (available from Showa Denko K.K.).
Eluent: Tetrahydrofuran (THF).
Flow rate: 1.0 ml/min.
Oven temperature: 40.0° C.
Amount of sample injected: 0.10 ml.

To calculate the molecular weight of the sample, a molecular weight calibration curve is used which is prepared using a standard polystyrene resin (e.g., trade name “TSK Standard Polystyrene F-850, F-450, F-288, F-128, F-80, F-40, F-20, F-10, F-4, F-2, F-1, A-5000, A-2500, A-1000, A-500”; available from Tosoh Corporation).

How to Measure Peak Temperature of Maximum Endothermic Peak of Wax and Glass Transition Temperature Tg of binder Resin or Toner

The peak temperature of a maximum endothermic peak of the wax is measured according to ASTM D3418-82, using a differential scanning calorimetry analyzer “Q1000” (manufactured by TA Instruments Japan Ltd.).

The temperature at the detecting portion of the instrument is corrected on the basis of melting points of indium and zinc, and the amount of heat is corrected on the basis of heat of fusion of indium.

Stated specifically, the wax is precisely weighed out in an amount of about 10 mg, and this is put into a pan made of aluminum and an empty pan made of aluminum is used as reference. Measurement is made at a heating rate of 10° C./min within the measurement temperature range of from 30° C. to 200° C. Here, in the measurement, the wax is first heated to 200° C., then cooled to 30° C. and thereafter heated again. In the course of this second-time heating, a maximum endothermic peak of a DSC curve in the temperature range of from 30° C. to 200° C. is taken as the maximum endothermic peak of the wax in the present invention.

As to the glass transition temperature (Tg) of the binder resin or toner, the binder resin or toner is precisely weighed out in an amount of about 10 mg, and measurement is made in the same way as that for the measurement of the peak temperature of the maximum endothermic peak of the wax. In that case, changes in specific heat are found within the range of temperature of from 40° C. or more to 100° C. or less. The point at which the middle-point line between the base lines of a differential thermal curve before and after the appearance of the changes in specific heat thus found and the differential thermal curve intersect is regarded as the glass transition temperature Tg of the binder resin or toner.

### Examples

The present invention is described below by giving specific working examples. The present invention is by no means limited to these working examples.

Magnetic Core Particles

### Production Example 1

Step 1 (Weighing and Mixing Step)

| | |
|---|---|
| Fe₂O₃ | 60.2% by mass |
| MnCO₃ | 33.9% by mass |
| Mg(OH)₂ | 4.8% by mass |
| SrCO₃ | 1.1% by mass |

Ferrite raw materials were so weighed out as to be in the above constituent ratio. Thereafter, these were ground and mixed for 2 hours by means of a dry-process ball mill making use of zirconia balls of 10 mm in diameter.

Step 2 (Provisional Baking Step)

After these were ground and mixed, the mixture obtained was baked at a temperature of 950° C. for 2 hours in the atmosphere by using a burner type baking furnace to produce provisionally baked ferrite. The ferrite was composed as shown below.

(MnO)_{0.387}(MgO)_{0.108}(SrO)_{0.010}(Fe₂O₃)_{0.495}

Step 3 (Grinding Step)

The provisionally baked ferrite was ground to a size of about 0.5 mm by means of a crusher, and thereafter, with addition of 30 parts by mass of water based on 100 parts by mass of the provisionally baked ferrite, the ground product was further ground for 2 hours by means of a wet-process ball mill making use of zirconia balls of 10 mm in diameter, to obtain slurry.

The slurry obtained was ground for 3 hours by means of a wet-process bead mill making use of zirconia beads of 1.0 mm in diameter, to obtain ferrite slurry.

Step 4 (Granulation Step)

To the ferrite slurry, 2.0 parts by mass of polyvinyl alcohol based on 100 parts by mass of the provisionally baked ferrite was added as a binder, and this ferrite slurry was granulated into spherical particles of about 36 μm by means of a spray dryer (manufactured by Ohkawara Kakohki Co., Ltd.).

Step 5 (Main Baking Step)

The granulated product was baked at a temperature of 1,050° C. for 4 hours while being kept in an atmosphere of nitrogen (oxygen concentration: 0.01% by volume or less) in an electric furnace in order to control baking atmosphere.

Step 6 (Screening Step)

Particles having come to agglomerate were disintegrated, followed by sifting with a sieve of 250 μm in mesh opening to remove coarse particles to obtain Magnetic Core Particles 1.

Magnetic Core Particles

### Production Example 2

Magnetic Core Particles 2 was produced in the same way as in Magnetic Core Particles Production Example 1 except that, in Magnetic Core Particles Production Example 1, the baking temperature of 1,150° C. in Step 5 was changed to 1,100° C.

Magnetic Core Particles

### Production Example 3

Magnetic Core Particles 3 was produced in the same way as in Magnetic Core Particles Production Example 1 except that, in Magnetic Core Particles Production Example 1, the grinding time of 2 hours of the wet-process bead mill in Step 3 was changed to 3 hours and the baking temperature of 1,150° C. in Step 5 was changed to 1,050° C.

Magnetic Core Particles

### Production Example 4

In Magnetic Core Particles Production Example 1, the zirconia balls of the wet-process ball mill in Step 3 were changed to stainless steel balls of 10 mm in diameter to carry out grinding for 2 hours. In Step 5 the baking temperature of 1,150° C. was changed to 1,200° .

Except the above, the procedure of Magnetic Core Particles Production Example 1 was repeated to obtain Magnetic Core Particles 4.

Magnetic Core Particles

### Production Example 5

In Magnetic Core Particles Production Example 1, in Step 3 the zirconia balls of the wet-process ball mill were changed to stainless steel balls of 10 mm in diameter and the grinding time of 2 hours of the wet-process bead mill was changed to 6 hours. In Step 5 the baking temperature of 1,150° C. was changed to 1,200° C.

Except the above, the procedure of Magnetic Core Particles Production Example 1 was repeated to obtain Magnetic Core Particles 5.

Magnetic Core Particles

### Production Example 6

In Magnetic Core Particles Production Example 5, the baking temperature of 1,150° C. in Step 5 was changed to 1,300° C.

Except the above, the procedure of Magnetic Core Particles Production Example 5 was repeated to obtain Magnetic Core Particles 6.

Magnetic Core Particles

### Production Example 7

In Magnetic Core Particles Production Example 1, the proportion of the ferrite raw materials in Step 1 was changed as shown below.

| | |
|---|---|
| Fe₂O₃ | 62.8% by mass |
| MnCO₃ | 30.1% by mass |
| Mg(OH)₂ | 6.4% by mass |
| SrCO₃ | 0.7% by mass |

The ferrite was composed as shown below.

(MnO)_{0.340}(MgO)_{0.143}(SrO)_{0.006}(Fe₂O₃)_{0.511}

In Step 3 the particle size of about 0.5 mm to which the material was ground by means of a crusher was changed to about 1.0 mm, the zirconia balls of the wet-process ball mill were changed to alumina balls of 10 mm in diameter and the grinding time of 2 hours was changed to 1 hour. The zirconia beads of the wet-process bead mill were changed to alumina beads of 1.0 mm in diameter, and the grinding time of 2 hours was changed to 3 hours.

In Step 4 the amount of 2 parts by mass of the polyvinyl alcohol added was changed to 5 parts by mass.

In Step 5 the baking temperature of 1,150° C. was changed to 1,000° C.

Except the above, the procedure of Magnetic Core Particles Production Example 1 was repeated to obtain Magnetic Core Particles 7.

Magnetic Core Particles

### Production Example 8

In Magnetic Core Particles Production Example 7, in Step 3 the particle size of about 1.0 mm to which the material was ground by means of a crusher was changed to about 0.3 mm, the alumina balls of the wet-process ball mill were changed to stainless steel balls of 10 mm in diameter. The alumina beads of the wet-process bead mill were changed to stainless steel beads of 1.0 mm in diameter, and the grinding time of 3 hours was changed to 4 hours.

In Step 4 the amount of 5 parts by mass of the polyvinyl alcohol added was changed to 2 parts by mass.

In Step 5 the baking atmosphere was changed to have an oxygen concentration of 1.00% by volume and the baking temperature of 1,000° C. was changed to 1,100° C.

Except the above, the procedure of Magnetic Core Particles Production Example 7 was repeated to obtain Magnetic Core Particles 8.

Magnetic Core Particles

### Production Example 9

To each of magnetite particles (intensity of magnetization in a magnetic field of 1,000/4π (kA/m): 75 Am²/kg) of 0.30 μm in number-average particle diameter and hematite particles of 0.60 μm in number-average particle diameter, 4.0% by mass of a silane compound 3-(2-aminoethylaminopropyl)trimethoxysilane was added, and these were mixed and agitated at a high speed in a container at a temperature of 100° C. or more to carry out treatment of both the fine particles.

| | |
|---|---|
| Phenol | 10 parts by mass |
| Formaldehyde solution | 6 parts by mass |
| (formaldehyde: 40% by mass; methanol: 10% by mass; | |
| water: 50% by mass) | |
| Above magnetite particles treated with silane | 58 parts by mass |
| compound | |
| Above hematite particles treated with silane compound | 26 parts by mass |

The above materials and 5 parts by mass of an aqueous 28% by mass ammonia solution and 20 parts by mass of water were put into a flask, and, with agitation and mixing, these were heated to 85° C. over a period of 30 minutes and held thereat to carry out polymerization reaction for 3 hours to cure the phenol resin being formed. Thereafter, the phenol resin cured was cooled to 30° C., and water was further added thereto. Thereafter, the supernatant liquid was removed, and then the precipitate formed was washed with water, followed by air drying. Subsequently, this was dried at a temperature of 60° C. under reduced pressure (5 mmHg or less) to obtain magnetic-material dispersed, spherical Magnetic Core Particles 9.

Magnetic Core Particles

### Production Example 10

In Magnetic Core Particles Production Example 1, in Step 3 the particle size of about 0.5 mm to which the material was ground by means of a crusher was changed to about 0.3 mm, the zirconia balls of the wet-process ball mill were changed to stainless steel balls of 10 mm in diameter and the grinding time of 2 hours was changed to 1 hour. The grinding time of 2 hours of the wet-process bead mill was changed to 1 hour.

In Step 5 the baking temperature of 1,150° C. was changed to 1,100° C.

Except the above, the procedure of Magnetic Core Particles Production Example 1 was repeated to obtain Magnetic Core Particles 10.

Magnetic Core Particles

### Production Example 11

Step 1

| | |
|---|---|
| Fe₂O₃ | 71.0% by mass |
| CuO | 12.5% by mass |
| ZnO | 16.5% by mass |

Ferrite raw materials were so weighed out as to be in the above compositional ratio. Thereafter, these were ground and mixed by means of a ball mill.

Step 2

After these were ground and mixed, the mixture obtained was baked at a temperature of 950° C. for 2 hours in the atmosphere to produce provisionally baked ferrite. The ferrite was composed as shown below.

(CuO)_{0.195}(ZnO)_{0.252}(Fe₂O₃)_{0.553}

Step 3

The provisionally baked ferrite was ground to a size of about 0.5 mm by means of a crusher, and thereafter, with addition of water, the ground product was further ground for 6 hours by means of a wet-process ball mill making use of stainless steel balls of 10 mm in diameter, to obtain ferrite slurry.

Step 4

To the ferrite slurry, 2 parts by mass of polyvinyl alcohol based on 100 parts by mass of the provisionally baked ferrite was added as a binder, and this ferrite slurry was granulated into spherical particles by means of a spray dryer (manufactured by Ohkawara Kakohki Co., Ltd.).

Step 5

The granulated product was baked at 1,300° C. for 4 hours in the atmosphere.

Step 6

Particles having come to agglomerate were disintegrated, followed by sifting with a sieve of 250 μm in mesh opening to remove coarse particles to obtain

Magnetic Core Particles 11.

### Magnetic Carrier Production Example 1

| | |
|---|---|
| Straight silicone resin | 20.0% by mass |
| (SR2411, available from Dow Corning Toray | |
| Silicone Co., Ltd.; dynamic viscosity in 20% by mass | |
| toluene solution: 1.1 × 10⁻⁴ m²/sec) | |
| γ-aminopropylethoxysilane | 0.5% by mass |
| Toluene | 79.0% by mass |

The above materials were so mixed as to be in the above compositional ratio to obtain Resin Solution 1.

Step 1 (Resin Filling Step)

100 parts by mass of Magnetic Core Particles 1 was put into an agitating container of a universal mixing agitator manufactured by Dulton Company Limited. While keeping its temperature at 30° C. and while producing a vacuum, nitrogen was introduced thereinto. Subsequently, Resin Solution 1 was so added as to be in an amount of 10 parts by mass as a resin component, based on the mass of Magnetic Core Particles 1. Then the agitation was continued for 2 hours as it was, and thereafter the temperature was raised to 70° C. to remove the solvent. The material obtained was moved to Julia Mixer (manufactured by Tokuju Corporation) to carry out heat treatment at a temperature of 200° C. for 2 hours in an atmosphere of nitrogen, followed by classification with a sieve of 70 μm in mesh opening to obtain Filled Core Particles 1.

Step 2 (Resin Coating Step)

100 parts by mass of Filled Core Particles 1 was put into Nauta mixer, manufactured by Hosokawa Micron Corporation, and Resin Solution 1 was further so put into Nauta Mixer as to be in an amount of 1.0 part by mass as a resin component. These were heated to a temperature of 70° C. under reduced pressure, and mixed at 1.7 S⁻¹ (100 rpm) to carry out the removal of solvent and resin coating over a period of 4 hours. Thereafter, the material obtained was moved to Julia Mixer to carry out heat treatment at a temperature of 200° C. for 2 hours in an atmosphere of nitrogen, followed by classification with a sieve of 70 μm in mesh opening to obtain Magnetic Carrier 1. Magnetic Carrier 1 obtained had a 50% particle diameter based on volume distribution (D50) of 36.5 μm.

### Magnetic Carrier Production Example 2

In Magnetic Carrier Production Example 1, the procedure of Step 1 was repeated to obtain Filled Core Particles 2, except that Magnetic Core Particles 1 was changed for Magnetic Core Particles 2 and the amount of 10 parts by mass for the resin added was changed to 12 parts by mass, and the procedure of Step 2 was repeated to obtain Magnetic Carrier 2, except that Filled Core Particles 2 was used instead. Magnetic Carrier 2 obtained had a 50% particle diameter based on volume distribution (D50) of 40.1 μm.

### Magnetic Carrier Production Example 3

In Magnetic Carrier Production Example 1, the procedure of Step 1 was repeated to obtain Filled Core Particles 3, except that Magnetic Core Particles 1 was changed for Magnetic Core Particles 3 and the amount of 10 parts by mass for the resin added was changed to 16 parts by mass, and the procedure of Step 2 was repeated to obtain Magnetic Carrier 3, except that Filled Core Particles 1 was changed for Filled Core Particles 3. Magnetic Carrier 3 obtained had a 50% particle diameter based on volume distribution (D50) of 36.3 μm.

### Magnetic Carrier Production Example 4

In Magnetic Carrier Production Example 1, the procedure of Step 1 was repeated to obtain Filled Core Particles 4, except that Magnetic Core Particles 1 was changed for Magnetic Core Particles 4 and the amount of 10 parts by mass for the resin added was changed to 12 parts by mass, and thereafter Step 2 (resin coating step) was not carried out to obtain Magnetic Carrier 4. Magnetic Carrier obtained had a 50% particle diameter based on volume distribution (D50) of 36.5 μm.

### Magnetic Carrier Production Example 5

In Magnetic Carrier Production Example 1, Step 1 was not carried out. Then, in Step 2 (resin coating step), Filled Core Particles 1 was changed for Magnetic Core Particles 4 and, using Resin Solution 1 and with agitation by means of a fluidized bed heated to a temperature of 80° C., the resin coating and removal of solvent were so carried out that the resin coating was in a solid content of 4.0 parts by mass based on 100 parts by mass of Magnetic Core Particles 4. Further, thereafter, the material obtained was moved to Julia Mixer to carry out heat treatment at a temperature of 200° C. for 2 hours in an atmosphere of nitrogen, followed by classification with a sieve of 70 μm in mesh opening to obtain Magnetic Carrier 5. Magnetic Carrier 5 obtained had a 50% particle diameter based on volume distribution (D50) of 35.8 μm.

### Magnetic Carrier Production Example 6

In Magnetic Carrier Production Example 1, Step 1 was not carried out, and Step 2 was carried out in the following way.

| | |
|---|---|
| Polymethyl methacrylate polymer | 10.0 parts by mass |
| (Mw: 66,000; dynamic viscosity in 20% by mass | |
| toluene solution: 8.4 × 10⁻⁵ m²/sec) | |
| BONTRON P51 | 2.0 parts by mass |
| (available from Orient Chemical Industries, Ltd.) | |
| Toluene | 88.0 parts by mass |

The above materials were dispersedly mixed by means of a bead mill to obtain Resin Solution 2.

100 parts by mass of Magnetic Core Particles 5 was put into Nauta mixer and Resin Solution 2 was further so put into Nauta Mixer as to be in an amount of 2.0 parts by mass as a resin component. These were heated to a temperature of 70° C. under reduced pressure, and mixed at 100 rpm to carry out the removal of solvent and resin coating over a period of 4 hours. Thereafter, the material obtained was moved to Julia Mixer to carry out heat treatment at a temperature of 100° C. for 2 hours in an atmosphere of nitrogen, followed by classification with a sieve of 70 μm in mesh opening to obtain Magnetic Carrier 6. Magnetic Carrier 6 obtained had a 50% particle diameter based on volume distribution (D50) of 41.8 μm.

### Magnetic Carrier Production Example 7

In Magnetic Carrier Production Example 6, its procedure was repeated to obtain Magnetic Carrier 6, except that, in Step 2, Magnetic Core Particles 5 was changed for Magnetic Core Particles 6 and the amount of 2.0 parts by mass for the resin component incorporated was changed to 0.3 part by mass. Magnetic Carrier 7 obtained had a 50% particle diameter based on volume distribution (D50) of 35.8 μm.

### Magnetic Carrier Production Example 8

In Magnetic Carrier Production Example 1, the procedure of Step 1 was repeated to obtain Filled Core Particles 5, except that Magnetic Core Particles 1 was changed for Magnetic Core Particles 7 and the amount of 10 parts by mass for the resin added was changed to 22 parts by mass. Then, Step 2 was carried out in the following way.

| | |
|---|---|
| Polymethyl methacrylate polymer | 10.0 parts by mass |
| (Mw: 66,000; dynamic viscosity in 20% by mass | |
| toluene solution: 8.4 × 10⁻⁵ m²/sec) | |
| Carbon black | 1.0 part by mass |
| (number-average particle diameter: 30 nm; DBP oil | |
| absorption: 50 ml/100 g) | |
| BONTRON P51 | 2.0 parts by mass |
| (available from Orient Chemical Industries, Ltd.) | |
| Toluene | 87.0 parts by mass |

The above materials were dispersedly mixed by means of a bead mill to obtain Resin Solution 3.

100 parts by mass of Filled Core Particles 5 was put into Nauta mixer and Resin Solution 3 was further so put into Nauta Mixer as to be in an amount of 2.0 parts by mass as a resin component. These were heated to a temperature of 70° C. under reduced pressure, and mixed at 100 rpm to carry out the removal of solvent and resin coating over a period of 4 hours. Thereafter, the material obtained was moved to Julia Mixer to carry out heat treatment at a temperature of 100° C. for 2 hours in an atmosphere of nitrogen, followed by classification with a sieve of 70 μm in mesh opening to obtain Magnetic Carrier 8. Magnetic Carrier 8 obtained had a 50% particle diameter based on volume distribution (D50) of 37.6 μm.

### Magnetic Carrier Production Example 9

In Magnetic Carrier Production Example 1, the procedure of Step 1 was repeated to obtain Filled Core Particles 6, except that Magnetic Core Particles 1 was changed for Magnetic Core Particles 8, and the procedure of Step 2 was repeated to obtain Magnetic Carrier 9, except that Filled Core Particles 6 was used instead. Magnetic Carrier 9 obtained had a 50% particle diameter based on volume distribution (D50) of 36.5 μm.

### Magnetic Carrier Production Example 10

In Magnetic Carrier Production Example 1, Step 1 was not carried out, and the procedure of Step 2 was repeated to obtain Magnetic Carrier 10, except that Filled Core Particles 1 was changed for Magnetic Core Particles 9 and the amount of 1.0 part by mass for the resin component incorporated was changed to 0.3 part by mass. Magnetic Carrier 10 obtained had a 50% particle diameter based on volume distribution (D50) of 37.5 μm.

### Magnetic Carrier Production Example 11

In Magnetic Carrier Production Example 1, the procedure of Step 1 was repeated to obtain Filled Core Particles 7, except that Magnetic Core Particles 1 was changed for Magnetic Core Particles 10 and the amount of 10 parts by mass for the resin added was changed to 12 parts by mass.

Then, as Step 2 (resin coating step), Filled Core Particles 1 was changed for Filled Core Particles 7 and, using Resin Solution 1 and with agitation by means of a fluidized bed heated to a temperature of 80° C., the resin coating and removal of solvent were so carried out that the resin coating was in a solid content of 2 parts by mass based on 100 parts by mass of Filled Core Particles 7. Further, thereafter, the material obtained was dried at room temperature for 24 hours, followed by classification with a sieve of 70 μm in mesh opening to obtain Magnetic Carrier 11. Magnetic Carrier 11 obtained had a 50% particle diameter based on volume distribution (D50) of 29.5 μm.

### Magnetic Carrier Production Example 12

In Magnetic Carrier Production Example 6, its procedure was repeated to obtain Magnetic Carrier 12, except that, in Step 2, Magnetic Core Particles 5 was changed for Magnetic Core Particles 11 and the amount of 2.0 parts by mass for the resin component incorporated was changed to 0.3 part by mass. Magnetic Carrier 12 obtained had a 50% particle diameter based on volume distribution (D50) of 38.5 μm.

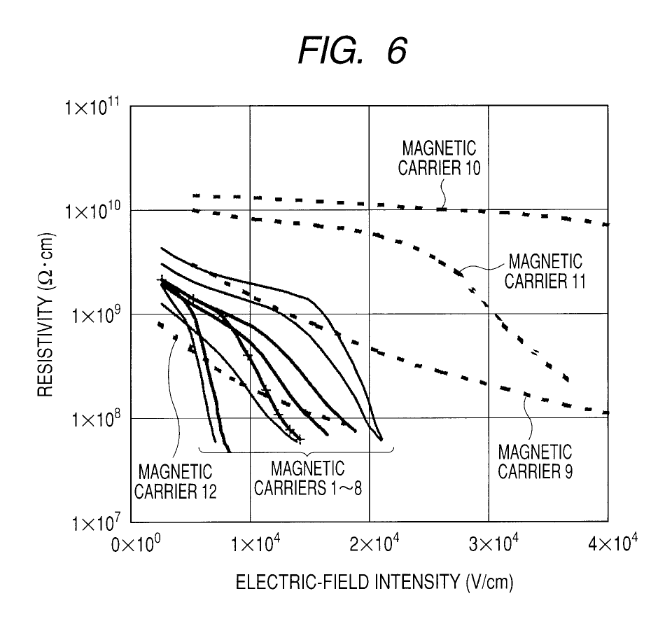

Formulation and physical properties of Magnetic Carriers 1 to 12 obtained are shown in Table 1-1 and Table 1-2. A graph about resistivity found by measuring the dynamic impedance of each magnetic carrier obtained is also shown in FIG. 6. Solid lines therein are about Magnetic Carriers 1 to 8, and dotted lines Magnetic Carriers 9 to 12.

TABLE 1-1
Formulation of Magnetic Carrier

| | Magnetic | | | Filling resin | | Coating resin | |
|---|---|---|---|---|---|---|---|
| Magnetic | Core | | Core | | Amount | | Amount |
| Carrier | Particles | Core type | resistance | Type | (pbm) | Type | (pbm) |
| 1 | 1 | Porous | 8.0 × 10⁶ | Silicone resin | 10 | Silicone resin | 1.0 |
| 2 | 2 | Porous | 9.6 × 10⁶ | Silicone resin | 12 | Silicone resin | 1.0 |
| 3 | 3 | Porous | 5.0 × 10⁶ | Silicone resin | 16 | Silicone resin | 1.0 |
| 4 | 4 | Porous | 1.2 × 10⁷ | Silicone resin | 12 | — | — |
| 5 | 4 | Porous | 3.0 × 10⁶ | — | — | Silicone resin | 4.0 |
| 6 | 5 | Bulky | 7.2 × 10⁶ | — | — | PMMA resin | 2.0 |
| 7 | 6 | Bulky | 1.2 × 10⁶ | — | — | PMMA resin | 0.3 |
| 8 | 7 | Porous | 5.2 × 10⁶ | Silicone resin | 22 | PMMA resin | 2.0 |
| 9 | 8 | Porous | 8.7 × 10⁷ | Silicone resin | 10 | Silicone resin | 1.0 |
| 10 | 9 | Magnetic = | 3.0 × 10¹² | — | — | Silicone resin | 0.3 |
| | | material | | | | | |
| | | dispersed | | | | | |
| 11 | 10 | Porous | 1.5 × 10⁷ | Silicone resin | 12 | Silicone resin | 2.0 |
| 12 | 11 | Bulky | 5.2 × 10⁷ | — | — | PMMA resin | 0.3 |

pbm: part(s) by mass

TABLE 1-2
Physical Properties of Carrier

| | Resistivity at | | | | | |
|---|---|---|---|---|---|---|
| | electric-field | Electric-field | Electric-field | | | |
| Magnetic | intensity of | intensity | intensity | E(10⁸)/ | Area | True specific |
| Carrier | 1.0 × 10³ V/cm | E(10⁹) | E(10⁸) | E(10⁹) | proportion | gravity |
| 1 | 2.6 × 10⁹ Ω · cm | 6.5 × 10³ V/cm | 1.4 × 10⁴ V/cm | 2.1 | 75 area % | 4.0 g/cm³ |
| 2 | 2.7 × 10⁹ Ω · cm | 8.0 × 10³ V/cm | 1.7 × 10⁴ V/cm | 2.1 | 65 area % | 3.6 g/cm³ |
| 3 | 2.7 × 10⁹ Ω · cm | 7.8 × 10³ V/cm | 2.5 × 10⁴ V/cm | 3.2 | 52 area % | 3.5 g/cm³ |
| 4 | 3.7 × 10⁹ Ω · cm | 1.2 × 10⁴ V/cm | 1.9 × 10⁴ V/cm | 1.6 | 88 area % | 4.1 g/cm³ |
| 5 | 3.5 × 10⁹ Ω · cm | 5.0 × 10³ V/cm | 7.0 × 10³ V/cm | 1.2 | 85 area % | 4.3 g/cm³ |
| 6 | 2.0 × 10⁹ Ω · cm | 3.7 × 10³ V/cm | 1.7 × 10⁴ V/cm | 4.6 | 94 area % | 4.8 g/cm³ |
| 7 | 3.2 × 10⁹ Ω · cm | 4.2 × 10³ V/cm | 5.7 × 10³ V/cm | 1.4 | 97 area % | 4.8 g/cm³ |
| 8 | 5.5 × 10⁹ Ω · cm | 1.6 × 10⁴ V/cm | 2.1 × 10⁴ V/cm | 1.6 | 45 area % | 3.3 g/cm³ |
| 9 | 6.0 × 10⁹ Ω · cm | 1.5 × 10⁴ V/cm | 3.5 × 10⁴ V/cm | 2.3 | 88 area % | 3.9 g/cm³ |
| 10 | 1.4 × 10¹⁰ Ω · cm | — | — | — | 98 area % | 3.9 g/cm³ |
| 11 | 2.0 × 10¹⁰ Ω · cm | 3.0 × 10⁴ V/cm | 3.5 × 10⁴ V/cm | 1.2 | 90 area % | 3.6 g/cm³ |
| 12 | 1.8 × 10⁹ Ω · cm | 3.0 × 10³ V/cm | 1.8 × 10⁴ V/cm | 6.0 | 100 area % | 4.8 g/cm³ |

### Binder Resin Production Example 1

71.0 parts by mass of polyoxypropylene(2.2)-2,2-bis(4-hydroxyphenyl)propane, 28.0 parts by mass of terephthalic acid, 1.0 part by mass of trimellitic anhydride and 0.5 part by mass of titanium tetrabutoxide were put into a 4-liter four-necked flask made of glass. Then, a thermometer, a stirring rod, a condenser and a nitrogen feed tube were attached thereto, and this was placed in a mantle heater. Next, the interior of the flask was displaced with nitrogen gas. Thereafter, the materials were gradually heated with stirring and, with stirring at a temperature of 200° C., allowed to react for 4 hours to obtain Binder Resin 1-1. This Binder Resin 1-1 had a weight average molecular weight (Mw) of 80,000, a number average molecular weight (Mn) of 3,500 and a peak molecular weight (Mp) of 5,700 in its molecular weight measured by GPC.

In addition, 70.0 parts by mass of polyoxypropylene(2.2)-2,2-bis(4-hydroxyphenyl)propane, 20.0 parts by mass of terephthalic acid, 3.0 parts by mass of isophthalic acid, 7.0 parts by mass of trimellitic anhydride and 0.5 part by mass of titanium tetrabutoxide were put into a 4-liter four-necked flask made of glass. Then, a thermometer, a stirring rod, a condenser and a nitrogen feed tube were attached thereto, and this was placed in a mantle heater. Next, the interior of the flask was displaced with nitrogen gas. Thereafter, the materials were gradually heated with stirring and, with stirring at a temperature of 220° C., allowed to react for 6 hours to obtain Binder Resin 1-2. This Binder Resin 1-2 had a weight average molecular weight (Mw) of 120,000, a number average molecular weight (Mn) of 4,000 and a peak molecular weight (Mp) of 7,800 in its molecular weight measured by GPC.

50 parts by mass of the above Binder Resin 1-1 and 50 parts by mass of Binder Resin 1-2 were preliminarily blended using Henschel mixer manufactured by Mitsui Miike Engineering Corporation, and then melt-blended by means of a melt-kneading machine PCM-30, manufactured by Ikegai Corp., under conditions of a number of revolutions of 3.3 s⁻¹ and a kneading resin temperature of 150° C. to obtain Binder Resin 1.

### Toner Production Example 1

| | | |
|---|---|---|
| Binder Resin 1 above | 100 | parts by mass |
| Fischer-Tropsch wax | 5 | parts by mass |
| (peak temperature of maximum endothermic | | |
| peak: 105° C.) | | |
| 3,5-Di-t-butylsalicylic acid aluminum compound | 0.5 | part by mass |
| C.I. Pigment Blue 15:3 | 8 | parts by mass |

The above materials were mixed using Henschel mixer (FM-75 Model, manufactured by Mitsui Miike Engineering Corporation), and thereafter the mixture obtained was kneaded by means of a twin-screw kneading machine (PCM-30 Model, manufactured by Ikegai Corp.) under conditions of a number of revolutions of 3.3 s⁻¹ and a kneading resin temperature of 130° C.

The kneaded product obtained was cooled, and then crushed by means of a hammer mill to a size of 1 mm or less to obtain a crushed product. The crushed product obtained was then finely pulverized by means of a mechanical grinding machine (T-250, manufactured by Turbo Kogyo Co., Ltd.). Further, the finely pulverized product obtained was classified by using a rotary classifier (200TSP, manufactured by Hosokawa Micron Corporation), and was so controlled that the particles having a circle-equivalent diameter of from 0.500 μm or more to less than 1.985 μm (small particles) were in a proportion of 5% by number to obtain Toner Particles 1. Toner Particles 1 obtained had a weight average particle diameter (D4) of 5.8 μm.

To 100 parts by mass of Toner Particles 1 obtained, 1.0 part by mass of fine titanium oxide particles of 50 nm in average primary particle diameter, having been surface-treated with 15% by mass of isobutyltrimethoxysilane, and 0.8 part by mass of hydrophobic fine silica powder of 16 nm in average primary particle diameter, having been surface-treated with 20% by mass of hexamethyldisilazane, were added and these were mixed using Henschel mixer (FM-75 Model, manufactured by Mitsui Miike Engineering Corporation) to obtain Toner 1. Toner 1 obtained had an average circularity C1 of 0.955 and an average circularity C2 of 0.935. Physical properties of Toner 1 obtained are shown in Table 2.

### Toner Production Example 2

Into 710 parts by weight of ion-exchanged water, 450 parts by mass of an aqueous 0.12 mol/l-Na₃PO₄ solution was introduced, and these were heated to a temperature of 60° C. The aqueous solution obtained was stirred at 250 s⁻¹ by means of a TK-type homomixer, manufactured by Tokushu Kika Kogyo Co., Ltd. Then, 68 parts by mass of an aqueous 1.2 mol/l-CaCl₂ solution was slowly added thereto to obtain an aqueous medium containing Ca₃(PO₄)₂.

| | | |
|---|---|---|
| C.I. Pigment Blue 15:3 | 10 | parts by mass |
| Styrene | 160 | parts by mass |
| n-Butyl acrylate | 30 | parts by mass |
| Paraffin wax | 20 | parts by mass |
| (peak temperature of maximum endothermic | | |
| peak: 78° C.) | | |
| 3,5-Di-t-butylsalicylic acid aluminum compound | 0.5 | part by mass |
| Polyester resin | 10 | parts by mass |
| (a polycondensation product of terephthalic acid | | |
| and polyoxypropylene(2.2)-2,2-bis(4- | | |
| hydroxyphenyl)propane; acid value: 15 | | |
| mgKOH/g; peak molecular weight: 6,000) | | |

The above materials were heated to a temperature of 60° C. and were put to uniform dissolution and dispersion at 166.7 s⁻¹ by means of the TK-type homomixer. In this mixture, 10 parts by mass of a polymerization initiator 2,2′-azobis(2,4-dimethylvaleronitrile) was dissolved to prepare a monomer mixture.

The monomer mixture obtained was introduced into the above aqueous medium to obtain a polymerizable monomer composition. The composition obtained was stirred at 200 s⁻¹(12,000 rpm) for 10 minutes by means of the TK-type homomixer at a temperature of 60° C. in an atmosphere of nitrogen to granulate the polymerizable monomer composition. Thereafter, with stirring using paddle stirring blades, the temperature was raised to 80° C. to carry out the reaction for 10 hours. After the polymerization reaction was completed, residual monomers were removed by evaporation under reduced pressure. The reaction mixture was cooled, and thereafter hydrochloric acid was added to dissolve the Ca₃ (PO₄)₂. The resultant solution was filtered, and the filtrate obtained was washed with water, followed by drying to obtain Toner Particles 2. This Toner Particles 2 had a weight average particle diameter (D4) of 6.7 μm.

To 100 parts by mass of Toner Particles 2 obtained, 0.8 part by mass of fine titanium oxide particles of 50 nm in average primary particle diameter, having been surface-treated with 15% by mass of isobutyltrimethoxysilane, and 0.7 part by mass of hydrophobic fine silica powder of 16 nm in average primary particle diameter, having been surface-treated with 20% by mass of hexamethyldisilazane, were added and these were mixed using Henschel mixer (FM-75 Model) to obtain Toner 2. Physical properties of Toner 2 obtained are shown in Table 2.

### Toner Production Example 3

Toner 3 was obtained in the same way as in Toner Production Example 1 except that the classification making use of the rotary classifier was carried out to make control so that the particles having a circle-equivalent diameter of from 0.500 μm or more to less than 1.985 μm (small particles) were in a proportion of 15% by number. Physical properties of Toner 3 obtained are shown in Table 2.

### Toner Production Example 4

Dispersion A

| | |
|---|---|
| Styrene | 350 parts by mass |
| n-Butyl acrylate | 100 parts by mass |
| Acrylic acid | 25 parts by mass |
| t-Dodecyl mercaptan | 10 parts by mass |

The above materials were mixed and dissolved to prepare a monomer mixture.

| | | |
|---|---|---|
| Paraffin wax dispersion with solid-matter | 100 | parts by mass |
| concentration of 30% | | |
| (peak temperature of maximum endothermic | | |
| peak: 78° C.) | | |
| Anionic surface-active agent | 1.2 | parts by mass |
| (NEOGEN SC, available from Dai-ichi Kogyo | | |
| Seiyaku Co., Ltd.) | | |
| Nonionic surface-active agent | 0.5 | part by mass |
| (NONIPOL 400, available from Sanyo Chemical | | |
| Industries, Ltd.) | | |
| Ion-exchanged water | 1,530 | parts by mass |

The above materials were put into a flask and made to effect dispersion, and were started to be heated while making displacement by nitrogen. At the time the liquid temperature came to a temperature of 70° C., a solution prepared by dissolving 6.56 parts by mass of potassium persulfate in 350 parts by mass of ion-exchanged water was put into this liquid. While keeping the liquid temperature at 70° C., the above monomer mixture was put thereinto and stirred, where the liquid temperature was raised to 80° C. and emulsion polymerization was continued for 6 hours as it was, and thereafter the liquid temperature was set to 40° C., followed by filtration with a filter to obtain Dispersion A, which had a weight average molecular weight (Mw) of 15,000 and a peak molecular weight of 12,000.

Dispersion B

| | |
|---|---|
| C.I. Pigment Blue 15:3 | 12 parts by mass |
| Anionic surface-active agent | 2 parts by mass |
| (NEOGEN SC, available from Dai-ichi Kogyo Seiyaku | |
| Co., Ltd.) | |
| Ion-exchanged water | 86 parts by mass |

The above materials were mixed to effect dispersion by means of a bead mill (ULTRA APEX MILL, manufactured by Kotobuki Industries Co., Ltd.) to obtain a colorant dispersion, Dispersion B.

300 parts by mass parts of the above Dispersion A and 25 by mass parts of Dispersion B were put into a 1-liter separable flask fitted with a stirrer, a condenser and a thermometer, and stirred therein. To this mixed dispersion, 180 parts by mass of an aqueous 10% by mass sodium chloride solution was dropwise added as an agglomerating agent, and the contents of the flask was heated to 54° C. in a heating oil bath. Their temperature was kept at 48° C. for 1 hour and thereafter the product obtained was observed on an optical microscope to ascertain that agglomerate particles of about 5 μm in diameter stood formed.

In the subsequent fusing step, 3 parts by mass of an anionic surface-active agent (NEOGEN SC, available from Daiichi Kogyo Seiyaku Co., Ltd.) was added to the above. Thereafter, the flask, which was made of stainless steel, was sealed off and, with stirring carried on by using Magnetic Seal, heated to 100° C., which was kept for 3 hours. Then, after cooling, the reaction product obtained was filtered, and washed sufficiently with ion-exchanged water, followed by drying to obtain Toner Particles 4. The toner particles obtained were analyzed to find that they contained 85 by mass parts of binder resin. This Toner Particles 4 had a weight average particle diameter (D4) of 5.5 μm.

To 100 parts by mass of the cyan particles Toner Particles 4 obtained, 1.0 part by mass of fine titanium oxide particles of 40 nm in average primary particle diameter, having been surface-treated with 10% by mass of isobutyltrimethoxysilane, 0.5 part by mass of hydrophobic fine silica powder of 20 nm in average primary particle diameter, having been surface-treated with 10% by mass of hexamethyldisilazane, and 1.5 parts by mass of hydrophobic fine silica powder of 110 nm in average primary particle diameter, having been surface-treated with 10% by mass of hexamethyldisilazane, were added and these were mixed using Henschel mixer to obtain Toner 4. Physical properties of Toner 4 obtained are shown in Table 2.

### Toner Production Example 5

Toner 5 was obtained in the same way as in Toner Production Example 1 except that the rotary classifier was changed for a multi-division classifier utilizing the Coanda effect and the particles having a circle-equivalent diameter of from 0.500 μm or more to less than 1.985 μm (small particles) were so controlled as to be in a proportion of 15% by number. Physical properties of Toner 5 obtained are shown in Table 2.

TABLE 2

| | Small = | | |
|---|---|---|---|
| | particle | Average | Average |
| | percentage | circularity | circularity |
| Toner | (% by number) | (1.985-39.69) | (0.500-1.985) |
| 1 | 5 | 0.955 | 0.935 |
| 2 | 10 | 0.970 | 0.955 |
| 3 | 15 | 0.955 | 0.935 |
| 4 | 25 | 0.960 | 0.950 |
| 5 | 32 | 0.930 | 0.935 |

### Example 1

10 parts by mass of Toner 1 and 90 parts by mass of Magnetic Carrier 1 were blended by means of a V-type mixer to obtain Two-component Developer 1.

Developing Performance Evaluation

A conversion machine of a full-color copying machine imagePRESS C1, manufactured by CANON INC., was used as an image forming apparatus. The above Two-component Developer 1 was put into its developing assembly at the cyan position, and images were reproduced to make evaluation.

As development conditions, the developing sleeve was so converted that its peripheral speed was 2.0 times that of the photosensitive drum. Then, an AC voltage of 1.5 kHz in frequency and 1.0 kV in peak-to-peak voltage (Vpp) and a DC voltage V_{DC} were applied to the developing sleeve. Running image reproduction (A4, 30% print percentage, 50,000 sheets) was tested in a normal-temperature and normal-humidity environment (temperature 23° C./humidity 50% RH), a normal-temperature and low-humidity environment (temperature 23° C./humidity 5% RH) and a high-temperature and high-humidity environment (temperature 32.5° C./humidity 80% RH) to make evaluation. Color Laser Copier Paper (A4, 81.4 g/m²), available from CANON Marketing Japan Inc., was used as evaluation paper.

The DC voltage V_{DC} was so controlled that the toner laid-on level on paper was 0.4 mg/cm² on FFH images (solid areas).

The FFH images refer to a value which indicates 256 gradations by 16-adic number, regarding 00H as the 1st gradation (white background) and FFH as the 256th gradation (solid areas).

Evaluation items and their evaluation criteria are shown below. The results of evaluation are also shown in Tables 4-1, 4-2 and 4-3.

(1) Image Density and Fog at Running Initial Stage and After Running on 50,000 Sheets

Development voltage was so controlled that the toner laid-on level on paper was 0.4 mg/cm² on images. X-Rite color reflection densitometer (500 Series; manufactured by X-Rite, Incorporated) was used to measure image density and fog.

i) A difference in image density between that at the running initial stage (1st sheet) and that after running on 50,000 sheets was evaluated according to the following criteria.

### (Evaluation Criteria)

A: Less than 0.05; best.
B: From 0.05 or more to less than 0.10; better.
C: From 0.10 or more to less than 0.20; good.
D: 0.20 or more; poor.

ii) Fog at the running initial stage (1st sheet) and after running on 50,000 sheets: Average reflectance Dr (%) of plain paper before image reproduction was measured with a reflection densitometer (REFLECTOMETER MODEL TC-6DS, manufactured by Tokyo Denshoku Co., Ltd.). Meanwhile, at the running initial stage and after running on 50,000 sheets, a solid white image (Vback: 150 V) was reproduced on plain paper. Reflectance Ds (%) of the solid white image reproduced was measured. From the Dr and Ds (at the running initial stage (1st sheet) and after running on 50,000 sheets) thus found, fog (%) was calculated by using the following expression. The fog found was evaluated according to the following criteria.

Fog (%)=Dr (%)−Ds (%)

(Evaluation Criteria)
A: Less than 0.5%; best.
B: From 0.5% or more to less than 1.0%; better.
C: From 1.0% or more to less than 2.0%; good.
D: 2.0% or more; poor.

(2) Dot Reproducibility at Running Initial Stage and After Running on 50,000 Sheets

Dot images were formed in which 1 pixel was formed of 1 dot. That is, the laser beam spot diameter of the above conversion machine was so adjusted that the area per dot on paper was 20,000 μm² or more to 25,000 μm² or less. The area of 1,000 dots was measured by using a digital microscope VHX-500 (lens: wide-range zoom lens VH-Z100; manufactured by Keyence Corporation).

Dot area number average (S) and dot area standard deviation (σ) were calculated, and a dot reproducibility index was calculated by using the following expression.

Expression

Dot reproducibility index (I)=τ/S×100.

(Evaluation Criteria)
A: Less than 4.0; best.
B: From 4.0 or more to less than 6.0; better.
C: From 6.0 or more to less than 8.0; good.
D: 8.0 or more; poor.

(3) Evaluation on Boundary Blanks

A chart was reproduced in which halftone horizontal zones (30H, 10 mm in width) and solid-black horizontal zones (FFH, 10 mm in width) were alternately arranged in the direction of transport of transfer sheet (i.e., images obtained by forming a halftone image of 10 mm in width over the whole region in the lengthwise direction of a photosensitive member, then forming a solid image of 10 mm in width over the whole region in the lengthwise direction thereof and repeating these). The images formed were read with a scanner (600 dpi), and were binary-coded. Luminance distribution (256 gradations) of the binary-coded images in the direction of transport was measured. In the luminance distribution obtained, the area of regions (the number of dots) having lower luminance than the halftone (30H) and looking white (regions of from 00H to 30H) was taken as the degree of boundary blanks, which was evaluated according to the following criteria.

### (Evaluation Criteria)

A: Less than 50; best.
B: From 50 or more to less than 200; better.
C: From 200 or more to less than 400; good.
D: 400 or more; poor.

(4) Carrier Sticking at Running Initial Stage and After Running on 50,000 Sheets

A halftone image (30H) was formed on paper, and the number of carrier particles present in a region of 1 cm² on the halftone image was counted on an optical microscope.

(Evaluation Criteria)
A: Less than 5 particles; best.
B: From 5 particles or more to less than 10 particles; better.
C: From 10 particles or more to 20 particles or less; good.
D: 21 particles or more; poor

### Examples 2 to 10 & Comparative Examples 1 to 5

Evaluation was made in the same way as in Example 1 except that the developer was changed for two-component developers shown in Table 3 below. The results of evaluation are shown in Tables 4-1, 4-2 and 4-3.

TABLE 3
Two-component Developers

| | Two-component | Magnetic | |
|---|---|---|---|
| | Developer | Carrier | Toner |
| Example 1 | 1 | 1 | 1 |
| Example 2 | 2 | 1 | 2 |
| Example 3 | 3 | 1 | 3 |
| Example 4 | 4 | 2 | 4 |
| Example 5 | 5 | 3 | 4 |
| Example 6 | 6 | 4 | 4 |
| Example 7 | 7 | 5 | 4 |
| Example 8 | 8 | 6 | 4 |
| Example 9 | 9 | 7 | 4 |
| Example 10 | 10 | 8 | 4 |
| Comparative | 11 | 9 | 1 |
| Example 1 | | | |
| Comparative | 12 | 9 | 5 |
| Example 2 | | | |
| Comparative | 13 | 10 | 1 |
| Example 3 | | | |
| Comparative | 14 | 11 | 1 |
| Example 4 | | | |
| Comparative | 15 | 12 | 1 |
| Example 5 | | | |

TABLE 4-1
Normal-temperature/Normal-humidity Environment (23° C./50% RH)

| | | Image density | | | Boundry | Carrier |
|---|---|---|---|---|---|---|
| | Image density | difference | Fog | Coarse images | blanks | sticking |
| | Initial stage | Initial stage | Initial stage | Initial stage | Initial stage | Initial stage |
| | → 50k sheets | → 50k sheets | → 50k sheets | → 50k sheets | → 50k sheets | → 50k sheets |
| Example: | | | | | | |
| 1 | 1.60→1.59 | A (0.01) | A (0.1)→A (0.1) | A (3.0)→A (3.2) | A (30)→A (40) | A (2)→A (3) |
| 2 | 1.60→1.59 | A (0.01) | A (0.1)→A (0.2) | A (3.1)→A (3.3) | A (30)→A (40) | A (2)→A (3) |
| 3 | 1.60→1.58 | A (0.02) | A (0.3)→A (0.4) | A (3.1)→A (3.4) | A (30)→A (40) | A (3)→A (4) |
| 4 | 1.60→1.57 | A (0.03) | A (0.4)→B (0.5) | A (3.5)→A (3.8) | B (80)→B (120) | B (5)→B (6) |
| 5 | 1.60→1.57 | A (0.03) | A (0.4)→B (0.5) | A (3.4)→A (3.7) | B (80)→B (120) | A (3)→A (4) |
| 6 | 1.60→1.56 | A (0.04) | B (0.5)→B (0.7) | B (4.1)→B (4.2) | B (110)→B (130) | B (6)→B (8) |
| 7 | 1.60→1.55 | B (0.05) | B (0.6)→B (0.8) | B (4.2)→B (4.4) | A (30)→A (40) | B (7)→B (8) |
| 8 | 1.60→1.55 | B (0.05) | B (0.6)→B (0.8) | B (4.3)→B (4.6) | A (40)→A (40) | B (8)→B (9) |
| 9 | 1.60→1.54 | B (0.06) | B (0.5)→B (0.7) | B (4.5)→B (4.8) | A (30)→A (40) | B (8)→B (9) |
| 10 | 1.60→1.52 | B (0.08) | B (0.8)→B (0.9) | B (4.8)→B (5.3) | B (150)→B (180) | B (9)→C (10) |
| Comparative Example: | | | | | | |
| 1 | 1.60→1.55 | B (0.05) | B (0.6)→B (0.9) | C (6.1)→C (6.5) | B (130)→B (150) | C (12)→C (15) |
| 2 | 1.60→1.54 | B (0.06) | C (1.2)→C (1.3) | C (6.2)→C (6.6) | B (150)→B (180) | C (15)→C (18) |
| 3 | 1.60→1.48 | C (0.12) | C (1.5)→C (1.8) | B (4.8)→C (6.1) | D (450)→D (500) | B (8)→C (18) |
| 4 | 1.60→1.55 | B (0.05) | C (1.2)→C (1.5) | B (4.5)→C (5.5) | C (320)→C (350) | C (15)→C (18) |
| 5 | 1.60→1.54 | B (0.06) | C (1.5)→C (1.8) | C (6.5)→C (6.8) | B (190)→C (320) | D (25)→D (28) |

50k: 50,000

TABLE 4-2
Normal-temperature/Low-humidity Environment (23° C./50% RH)

| | | Image density | | | Boundry | |
|---|---|---|---|---|---|---|
| | Image density | difference | Fog | Coarse images | blanks | Carrier sticking |
| | Initial stage | Initial stage | Initial stage | Initial stage | Initial stage | Initial stage |
| | → 50k sheets | → 50k sheets | → 50k sheets | → 50k sheets | → 50k sheets | → 50k sheets |
| Example: | | | | | | |
| 1 | 1.60→1.57 | A (0.03) | A (0.2)→A (0.4) | A (3.1)→A (3.8) | B (80)→B (120) | A (3)→B (5) |
| 2 | 1.60→1.56 | A (0.04) | A (0.3)→A (0.4) | A (3.3)→A (3.5) | B (90)→B (120) | A (3)→B (6) |
| 3 | 1.60→1.57 | A (0.03) | A (0.5)→B (0.5) | A (3.3)→A (3.6) | B (80)→B (120) | A (3)→B (5) |
| 4 | 1.60→1.55 | B (0.05) | B (0.5)→B (0.6) | B (4.3)→B (4.5) | B (130)→B (180) | B (6)→B (8) |
| 5 | 1.60→1.55 | B (0.05) | B (0.6)→B (0.7) | B (4.5)→B (4.6) | B (20)→B (180) | B (5)→B (6) |
| 6 | 1.60→1.50 | C (0.10) | B (0.7)→B (0.8) | B (4.8)→B (5.1) | B (190)→C (210) | B (8)→B (11) |
| 7 | 1.60→1.53 | B (0.07) | B (0.8)→C (1.1) | B (4.3)→B (4.5) | B (90)→B (110) | B (9)→C (15) |
| 8 | 1.60→1.52 | B (0.08) | B (0.8)→C (1.0) | B (4.5)→B (4.7) | B (80)→B (110) | C (11)→C (13) |
| 9 | 1.60→1.50 | C (0.10) | B (0.7)→C (1.0) | B (4.8)→B (5.1) | B (90)→B (120) | C (11)→C (15) |
| 10 | 1.60→1.49 | C (0.11) | C (1.1)→C (1.2) | B (5.1)→B (5.7) | B (180)→C (220) | C (13)→C (15) |
| Comparative Example: | | | | | | |
| 1 | 1.60→1.48 | C (0.12) | B (0.8)→C (1.2) | C (6.8)→C (7.3) | B (150)→C (210) | C (18)→D (22) |
| 2 | 1.60→1.47 | C (0.13) | C (1.5)→C (1.8) | C (7.1)→C (7.4) | B (160)→C (220) | D (25)→D (33) |
| 3 | 1.60→1.38 | D (0.22) | D (2.5)→D (3.1) | C (6.8)→C (7.4) | D (420)→D (550) | C (14)→C (18) |
| 4 | 1.60→1.52 | B (0.08) | B (0.8)→C (1.0) | B (4.5)→B (4.7) | C (380)→D (420) | C (11)→C (15) |
| 5 | 1.60→1.35 | D (0.25) | C (1.6)→C (1.9) | C (6.2)→C (6.5) | C (320)→C (350) | D (38)→D (42) |

50k: 50,000

TABLE 4-3
High-temperature/High-humidity Environment (32.5° C./80% RH)

| | | Image density | | | Boundry | |
|---|---|---|---|---|---|---|
| | Image density | difference | Fog | Coarse images | blanks | Carrier sticking |
| | Initial stage | Initial stage | Initial stage | Initial stage | Initial stage | Initial stage |
| | → 50k sheets | → 50k sheets | → 50k sheets | → 50k sheets | → 50k sheets | → 50k sheets |
| Example: | | | | | | |
| 1 | 1.60→1.55 | B (0.05) | B (0.5)→B (0.8) | B (5.1)→B (5.8) | B (70)→B (100) | B (5)→B (8) |
| 2 | 1.60→1.54 | B (0.06) | B (0.5)→B (0.8) | B (5.3)→B (5.6) | B (80)→B (100) | B (5)→B (8) |
| 3 | 1.60→1.54 | B (0.06) | B (0.8)→B (0.9) | B (5.4)→B (5.6) | B (70)→B (110) | B (5)→B (8) |
| 4 | 1.60→1.52 | B (0.08) | B (0.8)→B (0.9) | C (6.3)→C (6.6) | B (120)→B (150) | B (7)→C (10) |
| 5 | 1.60→1.51 | B (0.09) | C (1.0)→C (1.2) | C (6.5)→C (6.8) | B (110)→B (160) | B (7)→C (11) |
| 6 | 1.60→1.48 | C (0.12) | C (1.1)→C (1.1) | C (6.8)→C (7.3) | B (180)→C (200) | C (12)→C (15) |
| 7 | 1.60→1.50 | C (0.10) | C (1.3)→C (1.5) | C (6.9)→C (7.3) | B (80)→B (100) | B (10)→C (15) |
| 8 | 1.60→1.49 | C (0.11) | c (1.5)→C (1.3) | c (6.2)→C (6.3) | B (70)→B (90) | C (15)→C (19) |
| 9 | 1.60→1.47 | C (0.13) | C (1.0)→C (1.5) | C (7.1)→C (7.3) | B (80)→B (100) | C (15)→C (19) |
| 10 | 1.60→1.45 | C (0.15) | C (1.5)→C (1.7) | C (7.3)→C (7.9) | B (150)→C (200) | C (15)→C (19) |
| Comparative Example: | | | | | | |
| 1 | 1.60→1.45 | C (0.15) | C (1.5)→C (1.8) | C (7.8)→D (8.5) | B (180)→C (230) | C (18)→C (19) |
| 2 | 1.60→1.42 | C (0.18) | C (1.8)→C (1.9) | D (8.1)→D (8.6) | B (190)→C (240) | D (31)→D (38) |
| 3 | 1.60→1.42 | C (0.18) | D (3.1)→D (3.5) | C (6.5)→C (7.0) | D (550)→D (670) | C (18)→D (21) |
| 4 | 1.60→1.47 | C (0.13) | C (1.2)→C (1.9) | C (6.2)→C (6.5) | D (450)→D (510) | C (15)→C (18) |
| 5 | 1.60→1.42 | C (0.18) | D (4.0)→D (4.3) | C (7.5)→D (8.1) | C (330)→C (350) | D (40)→D (48) |

50k: 50,000

This application claims the benefit of Japanese Patent Application No. 2008-200643, filed Aug. 4, 2008, which is hereby incorporated by reference in its entirety.

What is claimed is:

1. A magnetic carrier comprising magnetic carrier particles, each magnetic carrier particle containing at least a magnetic core particle and a resin;
the magnetic carrier having a resistivity of from 1.0×10⁶ Ω·cm or more to 1.0×10¹⁰ Ω·cm or less at an electric-field intensity of 1.0×10³ V/cm as found by measuring dynamic impedance;
electric-field intensity E(10⁹) at which the resistivity of the magnetic carrier comes to 1.0×10⁹ Ω·cm being 2.0×10⁴ V/cm or less, and electric-field intensity E(10⁸) at which the resistivity of the magnetic carrier comes to 1.0×10⁸ Ω·cm being from 5.0×10³ V/cm or more to 2.8×10⁴ V/cm or less; and
the electric-field intensity E(10⁸) and the electric-field intensity E(10⁹) being in a ratio, E(10⁸)/E(10⁹), of from 1.0 or more to 5.0 or less.

2. The magnetic carrier according to claim 1, wherein, in a backscattered electron image of cross sections of the magnetic carrier particles as photographed with a scanning electron microscope, the magnetic core particle is in a sectional-area proportion of from 50 area % or more to 95 area % or less, to the sectional area of the magnetic carrier particles each.

3. The magnetic carrier according to claim 1, wherein the magnetic core particle is a porous magnetic core particle.

4. The magnetic carrier according to claim 3, wherein the pores of the porous magnetic core particle are filled with a resin.

5. The magnetic carrier according to claim 1, wherein the magnetic carrier particles are each coated with a resin on their surfaces.

6. A two-component developer comprising a magnetic carrier and a toner;
the magnetic carrier being the magnetic carrier according to claim 1.

7. The two-component developer according to claim 6, wherein, in the toner, particles having a circle-equivalent diameter of from 0.500 μm or more to less than 1.985 μm as measured with a flow type particle image analyzer having an image processing resolution of 512×512 pixels (0.37 μm×0.37 μm per pixel) are in a proportion of 30% by number or less.

8. The two-component developer according to claim 7, wherein the toner has an average circularity C1 of from 0.940 or more to 1.000 or less for its particles having a circle-equivalent diameter of from 1.985 μm or more to less than 39.69 μm as measured with the flow type particle image analyzer, where average circularity C2 of the particles having a circle-equivalent diameter of from 0.500 μm or more to less than 1.985 μm (small-particle toner) is smaller than the average circularity C1, C2<C1.

9. A an image forming method comprising:
a charging step of charging an electrostatic latent image bearing member electrostatically by a charging means;
an exposure step of exposing to light the electrostatic latent image bearing member thus charged, to form an electrostatic latent image thereon;
a developing step of forming a magnetic brush on a developer carrying member by means of a two-component developer and, in the state the magnetic brush is brought into contact with, and between, the electrostatic latent image bearing member and the developer carrying member, applying development bias across the electrostatic latent image bearing member and the developer carrying member to form an electric field across the electrostatic latent image bearing member and the developer carrying member, during which the electrostatic latent image is developed with a toner the two-component developer has, to form a toner image on the electrostatic latent image bearing member;
a transfer step of transferring the toner image from the electrostatic latent image bearing member to a transfer material via, or not via, an intermediate transfer member;
and a fixing step of fixing the toner image held on the transfer material, by the action of heat and/or pressure;
the two-component developer being the two-component developer according to claim 6, and the development bias being formed by superimposing an alternating electric field on a direct-current electric field.
